(19) United States
(12) Patent Application Publication
(10) Pub. No.: US 2025/0344054 A1
(43) Pub. Date: Nov. 6, 2025

(54) TRANSMISSION METHOD AND APPARATUS

(71) Applicant: VIVO MOBILE COMMUNICATION CO., LTD., Dongguan (CN)

(72) Inventors: Jiamin LIU, Dongguan (CN); Jinhua LIU, Dongguan (CN)

(73) Assignee: VIVO MOBILE COMMUNICATION CO., LTD., Dongguan (CN)

(21) Appl. No.: 19/255,961

(22) Filed: Jun. 30, 2025

Related U.S. Application Data
(63) Continuation of application No. PCT/CN2023/142091, filed on Dec. 26, 2023.

(30) Foreign Application Priority Data
Dec. 29, 2022 (CN) 202211716148.6

(51) Int. Cl. H04W 8/24; H04W 76/27

(52) U.S. Cl. CPC H04W 8/24; H04W 76/27

(57) ABSTRACT

A transmission method and apparatus, and pertains to the field of communication technologies. The method includes: receiving, by a first communication node, a feedback signal from an ambient power-enabled internet of things Ambient IoT device; and sending, by the first communication node, related information of the Ambient IoT device to a second communication node through a transmission channel of the first communication node.

### CROSS-REFERENCE TO RELATED APPLICATIONS

This application is a continuation of International Application No. PCT/CN2023/142091, filed on Dec. 26, 2023, which claims priority to Chinese Patent No. 202211716148.6, filed on Dec. 29, 2022. The entire contents of each of the above-referenced applications are expressly incorporated herein by reference in its entirety.

### TECHNICAL FIELD

This application pertains to the field of communication technologies, and specifically relates to a transmission method and apparatus.

### BACKGROUND

To accelerate implementation and deployment of an Ambient power-enabled Internet of Things (Ambient IoT) device in a 3rd Generation Partnership Project (3GPP) network, an architecture and a transmission manner of a 3GPP wireless communication network may be considered for bearing and supporting transmission of the Ambient IoT device.

A manner of processing User Equipment (UE) data in the 3GPP wireless communication network requires not only a complex protocol stack structure and a processing capability of the Ambient IoT device, but also a high requirement for power consumption, which is difficult to be applied to massive Ambient IoT devices with ultra-low capabilities or ultra-low manufacturing costs. Therefore, a data transmission processing manner in a communication system has poor practicality for data transmission of the Ambient IoT device.

### SUMMARY

Embodiments of this application provide a transmission method and apparatus.

According to a first aspect, a transmission method is provided, and the method includes:
receiving, by a first communication node, a feedback signal from an ambient power-enabled internet of things Ambient IoT device; and
sending, by the first communication node, related information of the Ambient IoT device to a second communication node through a transmission channel of the first communication node.

According to a second aspect, a transmission method is provided, and the method includes:
receiving, by a second communication node through a transmission channel of the second communication node, related information of an Ambient IoT device and sent by a first communication node.

According to a third aspect, a transmission method is provided, and the method includes:
receiving, by a third communication node, through a transmission channel of the third communication node, requirement information of an Ambient IoT service and sent by a first communication node.

According to a fourth aspect, a transmission apparatus is provided, and the apparatus includes:
a first receiving module, configured to receive a feedback signal from an ambient power-enabled internet of things Ambient IoT device; and
a first sending module, configured to send related information of the Ambient IoT device to a second communication node through a transmission channel of the first communication node.

According to a fifth aspect, a transmission apparatus is provided, and the apparatus includes:
a third receiving module, configured to receive, through a transmission channel of a second communication node, related information of an Ambient IoT device and sent by a first communication node.

According to a sixth aspect, a transmission apparatus is provided, and the apparatus includes:
a fourth receiving module, configured to receive, through a transmission channel of a third communication node, requirement information of an Ambient IoT service and sent by a first communication node.

According to a seventh aspect, a first communication node is provided. The first communication node includes a processor and a memory, the memory stores a program or an instruction that can be run on the processor, and the program or the instruction is executed by the processor to implement the steps of the method according to the first aspect.

According to an eighth aspect, a first communication node is provided, including a processor and a communication interface. The communication interface is configured to:
receive a feedback signal from an ambient power-enabled internet of things Ambient IoT device; and
send related information of the Ambient IoT device to a second communication node through a transmission channel of the first communication node.

According to a ninth aspect, a second communication node is provided. The second communication node includes a processor and a memory, the memory stores a program or an instruction that can be run on the processor, and the program or the instruction is executed by the processor to implement the steps of the method according to the second aspect.

According to a tenth aspect, a second communication node is provided, including a processor and a communication interface. The communication interface is configured to:

receive, through a transmission channel of the second communication node, related information of an Ambient IoT device and sent by a first communication node.

According to an eleventh aspect, a third communication node is provided. The third communication node includes a processor and a memory, the memory stores a program or an instruction that can be run on the processor, and the program or the instruction is executed by the processor to implement the steps of the method according to the third aspect.

According to a twelfth aspect, a third communication node is provided, including a processor and a communication interface. The communication interface is configured to:
receive, through a transmission channel of the third communication node, requirement information of an Ambient IoT service and sent by a first communication node.

According to a thirteenth aspect, a transmission system is provided, including a first communication node, a second communication node, and a third communication node. The first communication node may be configured to execute the steps of the transmission method according to the first aspect, the second communication node may be configured to execute the steps of the transmission method according to the second aspect, and the third communication node may be configured to execute the steps of the transmission method according to the third aspect.

According to a fourteenth aspect, a readable storage medium is provided. The readable storage medium stores a program or an instruction, and the program or the instruction is executed by a processor to implement the steps of the method according to the first aspect, or the steps of the method according to the second aspect, or the steps of the method according to the third aspect.

According to a fifteenth aspect, a chip is provided. The chip includes a processor and a communication interface, the communication interface is coupled to the processor, and the processor is configured to run a program or an instruction to implement the steps of the method according to the first aspect, or the steps of the method according to the second aspect, or the steps of the method according to the third aspect.

According to a sixteenth aspect, a computer program/program product is provided. The computer program/program product is stored in a storage medium, and the computer program/program product is executed by at least one processor to implement the steps of the transmission method according to the first aspect, or the steps of the method according to the second aspect, or the steps of the method according to the third aspect.

In the embodiments of this application, after receiving a feedback signal from an ambient power-enabled internet of things Ambient IoT device, a first communication node sends related information of the Ambient IoT device to a second communication node through a transmission channel of the first communication node. In this way, a bearer architecture and a transmission manner of a communication system can be greatly utilized, and a special transmission attribute configuration guarantee can be provided for the Ambient IoT device, to ensure a transmission requirement of the Ambient IoT device and avoid more complexity. This is applicable to massive Ambient IoT devices with ultra-low capabilities or ultra-low manufacturing costs, thereby improving practicability of a data transmission processing manner of the communication system for data transmission of the Ambient IoT device.

### BRIEF DESCRIPTION OF DRAWINGS

FIG. 1 is a block diagram of a wireless communication system to which the embodiments of this application can be applied;

FIG. 2 is a schematic flowchart of receiving and sending data by a Tag according to a related technology;

FIG. 3 is a schematic diagram of an RFID process and a Tag state according to a related technology;

FIG. 4 is a first schematic flowchart of a transmission method according to an embodiment of this application;

FIG. 5 is a schematic diagram of an Ambient IoT system structure including a reader according to an embodiment of this application;

FIG. 6 is a schematic diagram of a system architecture in which a terminal serves as an agent according to an embodiment of this application;

FIG. 7 is a first schematic diagram of a protocol stack according to an embodiment of this application;

FIG. 8 is a second schematic diagram of a protocol stack according to an embodiment of this application;

FIG. 9 is a third schematic diagram of a protocol stack according to an embodiment of this application;

FIG. 10 is a fourth schematic diagram of a protocol stack according to an embodiment of this application;

FIG. 11 is a fifth schematic diagram of a protocol stack according to an embodiment of this application;

FIG. 12 is a schematic diagram of a system architecture in which a network node serves as an agent according to an embodiment of this application;

FIG. 13 is a sixth schematic diagram of a protocol stack according to an embodiment of this application;

FIG. 14 is a seventh schematic diagram of a protocol stack according to an embodiment of this application;

FIG. 15 is an eighth schematic diagram of a protocol stack according to an embodiment of this application;

FIG. 16 is a ninth schematic diagram of a protocol stack according to an embodiment of this application;

FIG. 17 is a second schematic flowchart of a transmission method according to an embodiment of this application;

FIG. 18 is a third schematic flowchart of a transmission method according to an embodiment of this application;

FIG. 19 is a first schematic structural diagram of a transmission apparatus according to an embodiment of this application;

FIG. 20 is a second schematic structural diagram of a transmission apparatus according to an embodiment of this application;

FIG. 21 is a third schematic structural diagram of a transmission apparatus according to an embodiment of this application;

FIG. 22 is a schematic structural diagram of a communication device according to an embodiment of this application;

FIG. 23 is a schematic structural diagram of hardware of a terminal according to an embodiment of this application;

FIG. 24 is a schematic structural diagram of hardware of a network node according to an embodiment of this application;

FIG. 25 is a schematic structural diagram of hardware of a second communication node according to an embodiment of this application; and

FIG. 26 is a schematic structural diagram of hardware of a third communication node according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill based on the embodiments of this application shall fall within the protection scope of this application.

In the specification and claims of this application, the terms “first”, “second”, and the like are intended to distinguish between similar objects but do not describe a specific order or sequence. It should be understood that the terms used in such a way are interchangeable in proper circumstances so that the embodiments of this application can be implemented in orders other than the order illustrated or described herein. Objects classified by “first” and “second” are usually of a same type, and the number of objects is not limited. For example, there may be one or more first objects. In addition, in the specification and claims, “and/or” represents at least one of connected objects, and a character “/” generally represents an “or” relationship between associated objects.

It should be noted that technologies described in the embodiments of this application are not limited to a Long Time Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. The following describes a New Radio (NR) system for example purposes, and NR terms are used in most of the following descriptions. These technologies can also be applied to applications other than an NR system application, such as a 6th Generation (6G) communication system.

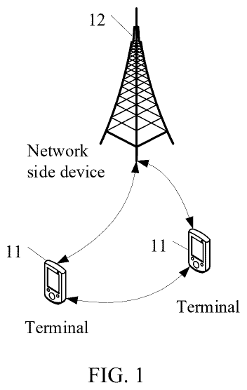

FIG. 1 is a block diagram of a wireless communication system to which the embodiments of this application can be applied. The wireless communication system includes a terminal 11 and a network side device 12. The terminal 11 may be a terminal side device such as a mobile phone, a tablet personal computer, a laptop computer or a notebook computer, a Personal Digital Assistant (PDA), a palmtop computer, a netbook, an ultra-mobile personal computer (UMPC), a Mobile Internet Device (MID), an augmented reality (AR)/virtual reality (VR) device, a robot, a wearable device, vehicle user equipment (VUE), pedestrian user equipment (PUE), a smart home (a home device with a wireless communication function, such as a refrigerator, a television, a washing machine, or a furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, and a smart chain), a smart wrist strap, a smart dress, and the like. It should be noted that a specific type of the terminal 11 is not limited in the embodiments of this application. The network side device 12 may include an access network device or a core network device. The access network device 12 may also be referred to as a radio access network device, a Radio Access Network (RAN), a radio access network function, or a radio access network unit. The access network device 12 may include a base station, a WLAN access point, a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmitting Receiving Point (TRP), or another appropriate term in the field. As long as a same technical effect is achieved, the base station is not limited to a specified technical term. It should be noted that, in this application, only a base station in an NR system is used as an example, and a specific type of the base station is not limited. The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), Unified Data Management (UDM), a Unified Data Repository (UDR), a Home Subscriber Server (HSS), a Centralized network configuration (CNC), a Network Repository Function (NRF), a Network Exposure Function (NEF), a Local NEF (L-NEF), a Binding Support Function (BSF), an Application Function (AF), and the like. It should be noted that, in the embodiments of this application, only a core network device in an NR system is used as an example for description, and a specific type of the core network device is not limited.

First, the following content is described:

### (1) Ambient Power-Enabled Internet of Things (Ambient IoT) (Including Passive IoT).

Ambient IoT is a 3GPP IoT technology. An Ambient IoT device has ultra-low complexity and ultra-low power consumption.

Ambient IoT is an IoT service, where an Ambient IoT device supplies energy through energy harvesting (energy harvesting), and the Ambient IoT device has no battery or has a limited energy storage capability, for example, energy storage using one capacitor. Energy sources for energy harvesting include a radio wave, light, motion, heat, or other suitable energy sources.

Energy of the Ambient IoT device is derived from energy harvesting. For energy storage, the Ambient IoT device may have the following features:
(a) battery-free with no energy storage, entirely dependent on an external energy source; or
(b) limited energy storage capability without requiring battery replacement or charging.

For example, the Ambient IoT device has no conventional battery. The Ambient IoT device itself may use energy harvested from a radio wave, where the radio wave may be from a network device or user equipment, such as a mobile phone UE.

For example, Ambient IoT devices may be classified based on an energy source, an energy storage capability, passive or active transmission, and the like.

For example, referring to a related technology, passive or active transmission of the Ambient IoT device includes the following plurality of communication modes:
(a) Normal operation: The Ambient IoT device has electric energy to support continuous operating or sustained operating for a period of time. Energy may be derived from continuous energy harvesting, or the Ambient IoT device may have a specified energy storage capability. For example, the Ambient IoT device is equipped with a capacitor.
(b) Active transmission: An operation triggered by the Ambient IoT device is supported. The Ambient IoT device can support only a short active state, and supports intermittent communication. The Ambient IoT device may decide when to communicate with a network. The Ambient IoT device does not necessarily monitor the network, that is, may not monitor a called service for a long time.
(c) Passive transmission: Only an on-demand operation initiated on the network side is supported. The Ambient IoT device cannot initiate a service by itself.

### (2) Information Transmission Between a Reader and a Backscatter (BSC) Device (for Example, an Electronic Tag Device, Also Referred to as a Tag Device) in Radio Frequency Identification (RFID).

RFID is a traditional backscatter communication system that can identify an ID and read data of a BSC device (a Tag device) within coverage of the reader. A process of identifying a Tag device and reading data is also referred to as inventory because RFID is initially applied to automated inventory of large quantities of goods.

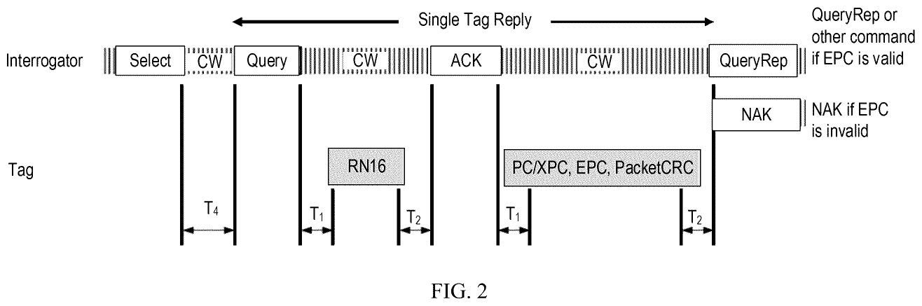

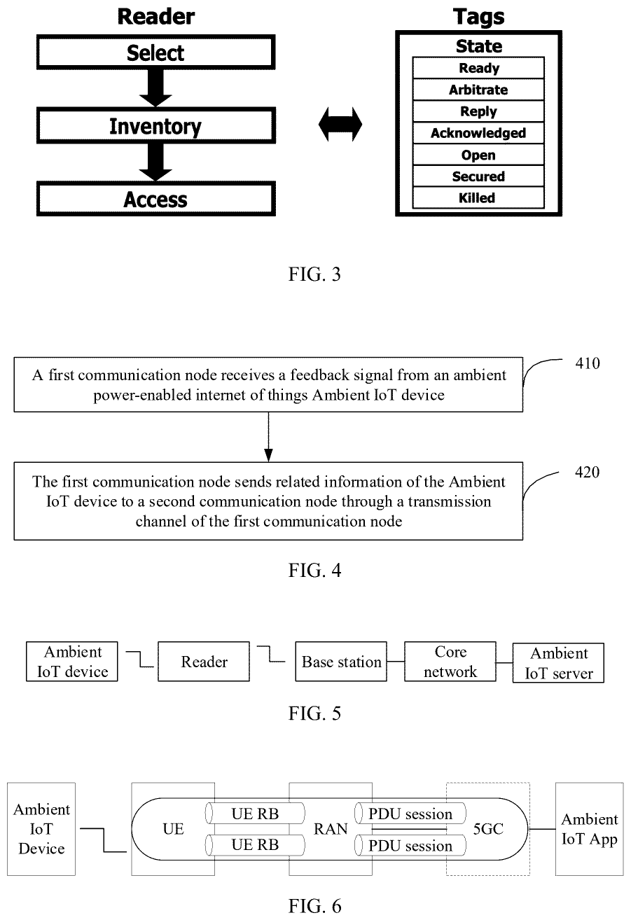

An EPC C1G2 RFID system defined in a related technology is used as an example. FIG. 2 is a schematic flowchart of receiving and sending data by a Tag device according to a related technology. FIG. 3 is a schematic diagram of an RFID process and a Tag state according to a related technology. As shown in FIG. 2 and FIG. 3, after a reader sends a query instruction, a Tag device responds with a reply. In an example in which the reply is RN16, the Tag device generates a 16-bit random number and sends the random number to the reader. Then, the reader sends the sequence to the Tag device through an acknowledgment (ACK) instruction. After successfully verifying the RN16 in the ACK, the Tag device sends subsequent data (such as PC/XPC or EPC) to the reader.

For examples of operation instructions of the reader, refer to the following Table 1:

TABLE 1

| Operation Type | Instruction | Function |
|---|---|---|
| Select | Select | Select a tag |
| Inventory | Query | Start an inventory action |
| | | Generate a random number to determine a response time |
| | Query Adjust | Adjust a quantity of original slots of a tag |
| | Query Repeat (QueryRep) | Tags are reduced by a quantity of slots of the tags |
| | EPC Acknowledgment (ACK) | A reader responds to an instruction for a tag |
| | NAK | Instruction sent by the reader |
| | | The tag returns to an arbitrate state |
| Access | Random Request (Req_RN) | The tag is required to generate a random number |
| | Read | Read data from a location in stored tags |
| | Write | Write the data to the stored tags |
| | Kill | No more response to any reader |
| | | Prevent privacy leakage |
| | | The tag cannot be used again |
| | Lock | No more writing action can be performed on the tag |
| | | Prevent the data from being tampered with at random |
| | Access (Optional) | When the tag has a password, change the tag from an open |
| | | state to a secure state |
| | BlockWrite (Optional) | Write a plurality of blocks at a time |
| | Lock Erase (Optional) | A plurality of blocks are cleared from stored single tags |

For examples of tag states of the Tag device, refer to Table 2:

TABLE 2

| Tag State | Description |
|---|---|
| Ready | Not in a current inventory operation |
| Arbitrate | This tag is currently in a specific inventory operation |
| | Indicating a number of a slot is not 0 and is still waiting |
| Reply | Generate a 16-bit random number to the reader |
| | A state in which acknowledgment is performed when one ACK message is received |
| | Return to an arbitrate state when no ACK message is received |
| Acknowledge | Enter any state other than a killed state from this state |
| Open | When an instruction of a random request is received when a tag whose password |
| | is not zero is in an acknowledgment state |
| Secure | A tag whose password is zero is received when an instruction of a random request |
| | sent by the reader is received in the acknowledgment state |
| Killed | Permanently unavailable |

In the related technology, data transmission of an Ambient IoT device via a 3GPP wireless communication network is not involved. The IoT device and the corresponding reader (interrogator reader) may be integrated into a mobile terminal or a fixedly deployed network node with a terminal function, but cannot be directly used as a node in a 3GPP wireless communication system. If the IoT device reuses an existing manner of processing UE data, a complex protocol stack structure and a processing capability are required for the Ambient IoT device (for example, a terminal), and power consumption is also directly required. These are not available for massive Ambient IoT devices with ultra-low capabilities/manufacturing costs. Therefore, a transmission method with acceptable complexity and effectiveness needs to be considered.

With reference to the accompanying drawings, the following describes in detail the transmission method and apparatus provided in the embodiments of this application by using some embodiments and application scenarios thereof.

FIG. 4 is a first schematic flowchart of a transmission method according to an embodiment of this application. As shown in FIG. 4, the method includes the following steps:

Step 410: A first communication node receives a feedback signal from an ambient power-enabled internet of things Ambient IoT device.

For example, the first communication node may be a node in a communication system.

For example, the first communication node may be a terminal.

For example, the first communication node may be a network node.

For example, the first communication node may be a base station (generation NodeB, gNB), or may be another network node with an air interface capability, for example, an Integrated access and backhaul (IAB) node, or a DU node in a Centralized Unit (CU)-Distributed Unit (DU) architecture.

For example, the first communication node may exist as a reader in an Ambient IoT system structure.

For example, the Ambient IoT device may provide the feedback signal for the first communication node through back scattering or active communication.

For example, the feedback signal may be sent by the Ambient IoT device.

For example, the feedback signal may be a signal that is reflected back to the first communication node by the Ambient IoT device after the first communication node sends a service signal.

For example, the feedback signal may be transmitted based on a normal operation communication mode of the Ambient IoT device.

For example, the feedback signal may be transmitted based on an active transmit communication mode of the Ambient IoT device.

For example, the feedback signal may be transmitted based on a passive transmit communication mode of the Ambient IoT device.

In an embodiment, FIG. 5 is a schematic diagram of an Ambient IoT system structure including a reader according to an embodiment of this application. As shown in FIG. 5, the reader may be the first communication node, for example, a handheld terminal, or may be a fixedly deployed or mobile deployed read-write device unit. The Ambient IoT device may be a terminal device based on passive communication or a terminal device based on active communication.

For example, communication between the reader and the Ambient IoT device may be based on a backward scattering communication mechanism, or may be based on an active communication manner in which the Ambient IoT device generates a transmit wave.

Step 420: The first communication node sends related information of the Ambient IoT device to a second communication node through a transmission channel of the first communication node.

For example, the second communication node may be an upper-layer node compared with the first communication node.

For example, the second communication node may be a base station.

For example, the second communication node may be a core network node.

For example, the second communication node may be an IoT server.

For example, the second communication node may be another external node.

For example, the related information of the Ambient IoT device may include Ambient IoT device information, IoT service signaling, or the like.

For example, the related information of the Ambient IoT device may include any information or signaling related to an IoT service, or any combination of information or signaling.

For example, the first communication node may send the related information of the Ambient IoT device to the second communication node through a transmission pipeline of the first communication node.

For example, if the first communication node is a terminal and the second communication node is a base station, the first communication node may transmit the related information of the Ambient IoT device by using an existing bearer between the terminal and the base station.

For example, the first communication node may directly communicate with massive Ambient IoT devices to complete signaling or signal delivery (for example, delivery of a service signal), and/or collect feedback and reporting information (for example, reporting of a feedback signal) from the Ambient IoT device.

For example, the first communication node may collect and report Ambient IoT device signaling or information or IoT service information or signaling by using a bearer of the first communication node to complete transmission.

For example, the transmission method provided in the embodiments of this application may be applicable to an Ambient IoT device that has no battery or power storage function, or may be applicable to an Ambient IoT device that has a battery or a power storage function.

For example, the transmission method provided in the embodiments of this application may be extended to Ambient IoT transmission requirements in 4G-LTE, 5G-NR, and a future 6G system. A specific implementation is similar, and details are not described herein again.

For example, in a communication system, when a reader-based Ambient IoT device system is used and the first communication node serves as a reader, uplink data collection and downlink signaling processes of the Ambient IoT device may be agented, and transmission may be performed through its pipeline. In this way, an existing bearer architecture and a transmission manner of the communication system can be greatly utilized, and a special transmission attribute configuration guarantee can be provided for the Ambient IoT device, to ensure a transmission requirement of the Ambient IoT device and avoid more complexity to a network, thereby accelerating rapid landing and deployment application of an Ambient IoT technology.

In this embodiment of this application, an Ambient IoT transmission requirement is introduced into a 3GPP network, and a terminal or a network node uses a bearer thereof to perform agent transmission on Ambient IoT device information and signaling.

In this embodiment of this application, after receiving a feedback signal from an ambient power-enabled internet of things Ambient IoT device, a first communication node sends related information of the Ambient IoT device to a second communication node through a transmission channel of the first communication node. In this way, a bearer architecture and a transmission manner of a communication system can be greatly utilized, and a special transmission attribute configuration guarantee can be provided for the Ambient IoT device, to ensure a transmission requirement of the Ambient IoT device and avoid more complexity. This is applicable to massive Ambient IoT devices with ultra-low capabilities or ultra-low manufacturing costs, thereby improving practicability of a data transmission processing manner of the communication system for data transmission of the Ambient IoT device.

For example, before the receiving, by a first communication node, a feedback signal from an Ambient IoT device, the method further includes at least one of the following:
receiving, by the first communication node through the transmission channel, requirement information of an Ambient IoT service and sent by a third communication node; and
sending, by the first communication node, a service signal to the Ambient IoT device, where the service signal is used to trigger the feedback signal.

For example, the third communication node may be an upper-layer node compared with the first communication node.

For example, the third communication node may be a base station.

For example, the third communication node may be a core network node.

For example, the third communication node may be an IoT server.

For example, the third communication node may be another external node.

For example, the third communication node and the second communication node may be a same node.

For example, the third communication node and the second communication node may be different nodes.

For example, a protocol stack structure of the third communication node may be the same as a protocol stack structure of the second communication node.

For example, a protocol stack structure of the third communication node may be different from a protocol stack structure of the second communication node.

For example, a protocol stack structure of the third communication node and a protocol stack structure of the second communication node may be mutually referenced.

For example, the first communication node serves as a transmission agent, and instruction information of the first communication node for the Ambient IoT device may be from an upper-layer node, that is, the third communication node.

For example, the third communication node may generate the requirement information of the Ambient IoT service, and send the requirement information to the first communication node through a signaling process between the third communication node and the first communication node.

In an embodiment, there is a radio bearer between UE and a gNB, there is a PDU session between the gNB and a CN, and there is an IP channel between the CN and a server. Transmission between the UE (the first communication node) and the server (the second communication node and/or the third communication node) may be performed through a combination of a plurality of transmission channels such as radio bearer+PDU session+IP channel. Herein, the radio bearer is considered as the transmission channel of the first communication node, and the IP channel is considered as the transmission channel of the second communication node and/or the third communication node.

In an embodiment, the requirement information may include performing reading and writing on an Ambient IoT device.

In an embodiment, the requirement information may include inventorying the Ambient IoT device.

In an embodiment, the requirement information may include positioning the Ambient IoT device.

For example, the requirement information may indicate a requirement of any IoT service, and details are not described herein.

For example, the first communication node may receive, through the transmission channel of the first communication node, the requirement information of the Ambient IoT service and sent by the third communication node.

For example, after obtaining the requirement information, the first communication node may learn a requirement of the Ambient IoT service and execute the Ambient IoT service.

For example, when executing the Ambient IoT service, the first communication node may send the service signal to the Ambient IoT device, and expect feedback from the Ambient IoT device.

For example, that the first communication node sends the service signal to the Ambient IoT device may include: the first communication node sends a radio wave to the Ambient IoT device through an IoT interface, where the radio wave transmits energy and an Ambient IoT device operation instruction (a service signal) to the Ambient IoT device, so that the Ambient IoT device transmits the feedback signal, for example, sends the feedback signal through backward scattering or performs feedback after adding information of the Ambient IoT device or delay information by using an incoming wave. The Ambient IoT device operation instruction is generally used to indicate a response of the Ambient IoT device, for example, responding to inventory information, and a parameter and a manner to be used to respond to inventory information.

For example, the Ambient IoT device receives the service signal of the first communication node, and performs feedback and response based on signal content of the service signal.

For example, for a specific method and content in which the first communication node sends the service signal to the Ambient IoT device and performs feedback and response (that is, transmits the feedback signal) on the Ambient IoT device, reference may be made to behavior of RFID, or a new process may be designed based on RFID to adapt to the 3GPP system. This is not limited in this embodiment of this application.

For example, after receiving the feedback signal of the Ambient IoT device, the first communication node may report the related information of the Ambient IoT device to an upper-layer control node (the second communication node) based on the feedback signal.

In an optional embodiment, the third communication node that sends the requirement information to the first communication node and the second communication node that reports the Ambient IoT device to the first communication node may be a same node or different nodes. For example, one control node (the third communication node) is configured to generate an instruction, and another control node (a second control node) is configured to collect and process a response and feedback information, and then feeds back a generated result to a signaling control node to form closed-loop control.

For example, the first communication node may directly communicate with the Ambient IoT device to complete signaling or signal delivery, for example, delivery of a service signal.

For example, the first communication node may directly communicate with massive Ambient IoT devices to complete signaling or signal delivery, for example, delivery of a service signal.

For example, the first communication node may communicate with the Ambient IoT device based on a normal operation communication mode of the Ambient IoT device.

For example, the first communication node may communicate with the Ambient IoT device based on an active transmit communication mode of the Ambient IoT device.

For example, the first communication node may communicate with the Ambient IoT device based on a passive transmit communication mode of the Ambient IoT device.

In this embodiment of this application, the first communication node receives, through the transmission channel of the first communication node, the requirement information sent by the third communication node, and sends the service signal to the Ambient IoT device, to implement execution of IoT based on an instruction of an upper-layer node. In addition, a bearer architecture and a transmission manner of the communication system can be utilized to ensure a transmission requirement of the Ambient IoT device and avoid more complexity. This is applicable to massive Ambient IoT devices with ultra-low capabilities or ultra-low manufacturing costs, thereby further improving practicability of a data transmission processing manner of the communication system for data transmission of the Ambient IoT device.

For example, the first communication node communicates with the Ambient IoT device through an IoT layer, where the IoT layer is an independent protocol layer, or the IoT layer is a submodule of an IoT Medium Access Control (MAC) layer or an IoT Physical (PHY) layer.

For example, the first communication node may send the service signal to the Ambient IoT device through the IoT layer.

For example, the feedback signal of the Ambient IoT device may be transmitted through the IoT layer.

For example, the IoT layer is an independent protocol layer, that is, independent of another protocol layer in the communication system.

For example, the IoT layer is a submodule of the IoT MAC layer or the IoT PHY layer, that is, the IoT layer may be integrated into the IoT MAC layer or the IoT PHY layer as a submodule.

For example, FIG. 6 is a schematic diagram of a system architecture in which a terminal serves as an agent according to an embodiment of this application. As shown in FIG. 6, the first communication node may be a terminal (UE), and an Ambient IoT device may communicate with the terminal through an air interface. For example, an interaction process of an RFID link in the related technology is reused or an interaction process applicable to a 3GPP air interface is used.

For example, as shown in FIG. 6, in the system architecture in which a terminal serves as an agent, nodes such as a terminal (UE), a RAN node, and a possible 5GC node may all belong to nodes participating in communication in a 3GPP system, and each node operates with a 3GPP communication architecture and function as a baseline.

For example, as shown in FIG. 6, in the system architecture in which a terminal serves as an agent, UE interacts with an Ambient IoT device to deliver signaling or collect information. The delivered signaling may be from the third communication node, such as an Ambient IoT server, a 5GC or an internal RAN node, or another external control node. The UE may report information collected from an Ambient IoT node to these nodes. A bearer and a path of the UE may be reused for both delivery and reporting, and information arrives at a target node, that is, the second communication node, in a manner similar to that in a communication system.

For example, as shown in FIG. 6, in the system architecture in which a terminal serves as an agent, because signaling and reporting related to the Ambient IoT device (for example, the service signal or the related information of the Ambient IoT device) may have a special transmission requirement, an independent bearer and a dedicated transmission parameter may be configured for the Ambient IoT device. For example, when these information has a similar attribute to existing data of the UE, the information may be placed in a same bearer for transmission.

In this embodiment of this application, an independent protocol layer, or a submodule of an IoT (Medium Access Control (MAC) layer or an IoT Physical (PHY) layer is provided for communication between the first communication node and the Ambient IoT device. In this way, a transmission requirement of related signaling and reporting of the Ambient IoT device is met, and impact on another communication process can be avoided.

For example, in a case that the first communication node includes a terminal, the related information is carried in at least one of the following:
UE Non-Access Statrum (NAS) signaling, a Signaling Radio Bearer (SRB) 2, UE RRC signaling, an SRB1, a UP bearer of UE, a DRB, a data plane of UE, a bearer dedicated to Ambient IoT device data, and a first bearer, where
the first bearer is different from the SRB1, the SRB2, or the DRB.

In a case that the first communication node includes a terminal, the terminal may be referred to as agent UE or an agent terminal, which may be referred to as UE or a terminal for short.

For example, the UE may perform uplink transmission on the related information of the Ambient IoT device by using NAS signaling, RRC signaling, a user plane bearer, a data plane bearer, or a new bearer type (for example, the first bearer).

In this embodiment of this application, an existing bearer architecture and a transmission manner of the communication system are utilized between the first communication node and the second communication node to ensure a transmission requirement of the Ambient IoT device and avoid more complexity. This is applicable to massive Ambient IoT devices with ultra-low capabilities or ultra-low manufacturing costs, thereby further improving practicability of a data transmission processing manner of the communication system for data transmission of the Ambient IoT device.

For example, in a case that the first communication node includes a terminal, the requirement information is carried in at least one of the following:
UE NAS signaling, an SRB2, UE RRC signaling, an SRB1, a UP bearer of UE, a DRB, a data plane of UE, a bearer dedicated to Ambient IoT device data, and a first bearer, where
the first bearer is different from the SRB1, the SRB2, or the DRB.

For example, the UE may perform downlink transmission on Ambient IoT data (for example, the requirement information) by using NAS signaling, RRC signaling, a user plane bearer, a data plane bearer, or a new bearer type.

For example, the UE may perform uplink and downlink transmission on Ambient IoT data by using NAS signaling, RRC signaling, a user plane bearer, a data plane bearer, or a new bearer type.

For example, the UE may agent and transmit signaling and reporting of the Ambient IoT device by using NAS signaling.

In this embodiment of this application, an existing bearer architecture and a transmission manner of the communication system are utilized between the first communication node and the third communication node to ensure a transmission requirement of the Ambient IoT device and avoid more complexity. This is applicable to massive Ambient IoT devices with ultra-low capabilities or ultra-low manufacturing costs, thereby further improving practicability of a data transmission processing manner of the communication system for data transmission of the Ambient IoT device.

For example, the first communication node communicates with the second communication node through an IoT Agent, and/or the first communication node communicates with the third communication node through an IoT Agent, where the IoT Agent is an independent protocol layer, or the IoT Agent is a submodule of a NAS protocol layer.

For example, the UE NAS signaling is a signaling transmission pipeline between the first communication node and the second communication node such as an AMF. Transmission is performed between the first communication node and the second communication node through the SRB2.

For example, the UE NAS signaling is a signaling transmission pipeline between the first communication node and the third communication node such as an AMF. Transmission is performed between the first communication node and the third communication node through the SRB2.

For example, the first communication node is a terminal, the second communication node and/or the third communication node are/is a core network control node, and the UE NAS signaling is a signaling transmission pipeline between the UE and the core network control node such as an AMF. Transmission may be performed between UE and a gNB through the SRB2.

For example, in a case that the first communication node includes a terminal, the related information or the requirement information may be carried in the UE NAS signaling for transmission.

For example, in a case that the first communication node includes a terminal, the related information or the requirement information may be carried in a signaling transmission pipeline between UE and a core network control node for transmission.

For example, in a case that the first communication node includes a terminal, the related information or the requirement information may be carried in the SRB2 for transmission.

For example, the requirement information or the related information of the Ambient IoT device may be transmitted by using a new SRB different from the SRB2, so that different transmission priorities can be configured for the existing SRB2 and the new SRB. This avoids resource contention with existing NAS in a case that there is more requirement information or related information of the Ambient IoT device.

For example, in a case that the first communication node includes a terminal, a dedicated transmission pipeline may be established between the first communication node and the second communication node, and the related information of the Ambient IoT device may be placed in a NAS signaling container for transmission by using NAS signaling in the related technology or new NAS signaling.

For example, in a case that the first communication node includes a terminal, communication may be performed between the second communication node and an Ambient IoT control node through a pre-planned path or a specified IP address.

In an embodiment, a dedicated transmission pipeline may be established between a gNB and an AMF, and the related information of the Ambient IoT device may be placed in a NAS signaling container for transmission by using existing NAS signaling or new NAS signaling. Communication may be performed between an AMF and an Ambient IoT control node through a pre-planned path or a specified IP address.

For example, in a case that the first communication node includes a terminal, a dedicated transmission pipeline may be established between the first communication node and the third communication node, and the related information of the Ambient IoT device may be placed in a NAS signaling container for transmission by using NAS signaling in the related technology or new NAS signaling.

For example, communication may be performed between the third communication node and an Ambient IoT control node through a pre-planned path or a specified IP address.

In an embodiment, a dedicated transmission pipeline may be established between a gNB and an AMF, and the requirement information may be placed in a NAS signaling container for transmission by using existing NAS signaling or new NAS signaling. Communication may be performed between an AMF and an Ambient IoT control node through a pre-planned path or a specified IP address.

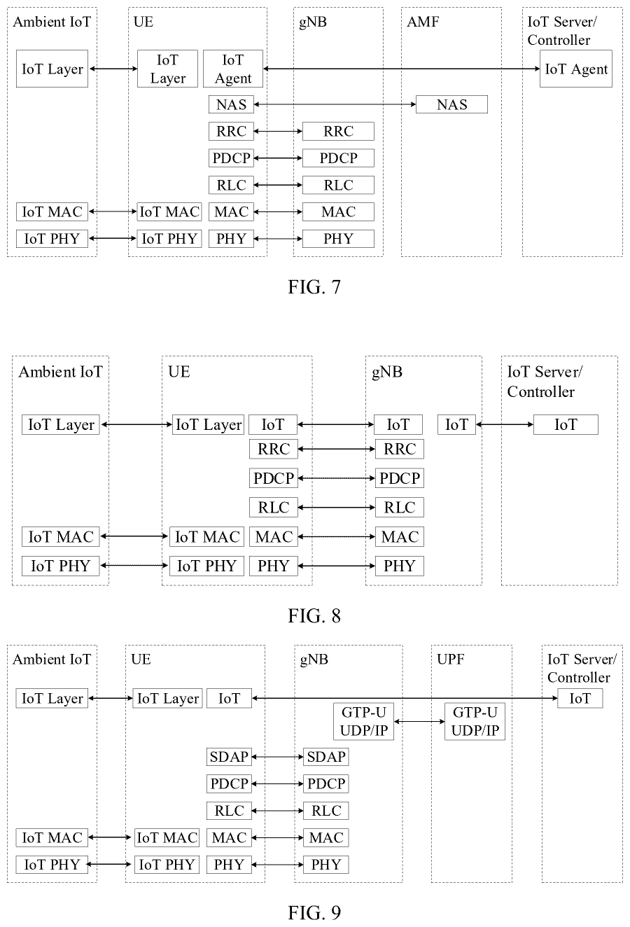

FIG. 7 is a first schematic diagram of a protocol stack according to an embodiment of this application. As shown in FIG. 7, an IoT layer and/or an IoT Agent may be optional. For example, an IoT agent may be an independent protocol layer or may be integrated into a NAS protocol stack as a submodule, or an IoT layer may be an independent protocol layer or may be integrated into an IoT MAC layer or an IoT PHY layer as a submodule.

In this embodiment of this application, an independent protocol layer or a submodule of a NAS protocol layer is provided for communication between the first communication node and an upper-layer node (the second communication node and/or the third communication node). In this way, a transmission requirement of related signaling and reporting of the Ambient IoT device is met, and impact on another communication process can be avoided.

For example, the first communication node communicates with the second communication node through an IoT protocol layer, and/or the first communication node communicates with the third communication node through an IoT protocol layer, where the IoT protocol layer is an independent protocol layer, or the IoT protocol layer is a submodule of an RRC protocol layer, or the IoT protocol layer is a submodule of an interface protocol layer, or the IoT protocol layer is a submodule of an APP protocol layer, or the IoT protocol layer is a submodule of a first protocol layer, where the first protocol layer is different from the RRC protocol layer, the interface protocol layer, or the APP protocol layer.

For example, in a case that the first communication node includes a terminal, the UE RRC signaling is a signaling transmission pipeline between the first communication node and the second communication node.

For example, in a case that the first communication node includes a terminal, the UE RRC signaling is a signaling transmission pipeline between the first communication node and the third communication node.

For example, the first communication node is UE, the second communication node and/or the third communication node are/is a gNB control node, and the UE RRC signaling is a signaling transmission pipeline between the UE and the gNB control node such as a CU.

For example, in a case that the first communication node includes a terminal, transmission may be performed between the first communication node and the third communication node through the SRB1.

For example, transmission may be performed between the first communication node and the second communication node through the SRB1.

In an embodiment, transmission may be performed between gNBs through the SRB1. RRC signaling generally terminates at a gNB. If the RRC signaling needs to reach another node, a transmission path and an address may be preconfigured between the gNB and the another node.

For example, the related information or the requirement information may be carried in a signaling transmission pipeline between the first communication node and the second communication node for transmission.

For example, the related information or the requirement information may be carried in a signaling transmission pipeline between the first communication node and the third communication node.

For example, the related information or the requirement information may be carried in a signaling transmission pipeline between UE and a gNB control node for transmission.

For example, the related information or the requirement information may be carried in a signaling transmission pipeline between UE and a CU.

For example, the related information or the requirement information may be transmitted through the SRB1.

For example, FIG. 8 is a second schematic diagram of a protocol stack according to an embodiment of this application. As shown in FIG. 8, the protocol stack may be a protocol stack in an RRC signaling bearer manner. An IoT layer and/or an IoT protocol layer (IoT in FIG. 8) may be optional. For example, an IoT protocol layer (IoT in FIG. 8) between UE and a gNB may be an independent protocol layer or may be integrated into an RRC protocol stack as a submodule; or an IoT protocol layer (IoT in FIG. 8) between a gNB and an IoT server/controller may be an independent protocol layer or may be a part of an APP protocol, or may be integrated into an interface protocol layer as a submodule; or an IoT layer may be an independent protocol layer or may be integrated into an IoT MAC layer or an IoT PHY layer as a submodule.

For example, to distinguish RRC signaling transmission between UE and a base station in the related technology, a new SRB may be defined for transmission of the requirement information or the related information of the Ambient IoT device.

For example, the UP bearer of the UE may be used for transmission of the requirement information or the related information of the Ambient IoT device.

For example, the UP bearer of the UE may be a data pipeline between the first communication node and the second communication node.

For example, the UP bearer of the UE may be a data pipeline between the first communication node and the third communication node.

For example, transmission between the first communication node and the second communication node may be carried through the DRB.

For example, transmission between the first communication node and the third communication node may be carried through the DRB.

For example, transmission between the first communication node and the second communication node may be carried through the PDU session and/or the GTP-U tunnel.

For example, transmission between the first communication node and the third communication node may be carried through the PDU session and/or the GTP-U tunnel.

For example, a dedicated pipeline may be established between the first communication node and the third communication node for an IoT requirement, or a UP pipeline in the related technology may be reused.

For example, a dedicated pipeline may be established between the first communication node and the second communication node for an IoT requirement, or a UP pipeline in the related technology may be reused.

In an embodiment, the UP bearer of the UE is a data pipeline between the UE and a core network user plane node such as a UPF. Transmission is carried between the UE and a gNB through the DRB and is carried between the gNB and the UPF through the PDU session and the GTP-U tunnel. A dedicated pipeline may be established for an IoT requirement according to a UP pipeline establishment mechanism in the related technology, or a UP pipeline in the related technology is reused. A transmission path and an address need to be preconfigured for data transmission between the UPF and an external control node or a server.

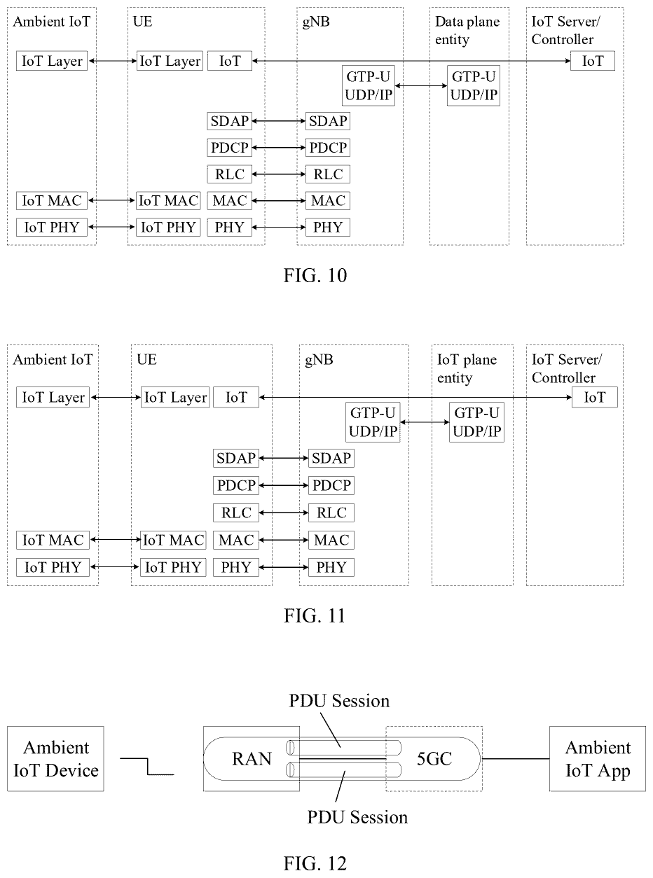

For example, FIG. 9 is a third schematic diagram of a protocol stack according to an embodiment of this application. As shown in FIG. 9, the protocol stack may be a protocol stack in a UP bearer manner. An IoT layer and/or an IoT protocol layer (IoT in FIG. 9) may be optional. For example, an IoT protocol layer (IoT in FIG. 9) between UE and an IoT server/controller may be an independent protocol layer or a part of an APP protocol, or may be integrated into another protocol layer as a submodule; or an IoT layer may be an independent protocol layer or may be integrated into an IoT MAC layer or an IoT PHY layer as a submodule.

For example, the data plane of the UE may be used for transmission of the requirement information or the related information of the Ambient IoT device.

For example, transmission may be performed between the first communication node and the second communication node through the data plane of the UE.

For example, transmission may be performed between the first communication node and the third communication node through the data plane of the UE.

In an embodiment, the data plane of the UE is used. The data plane is a set function for emerging data collection and requirement processing, and may include IoT data collection and instruction delivery (the requirement information or the related information of the Ambient IoT device).

For example, the data plane bearer may have a relatively flexible construction manner. For example, the data plane bearer may involve specific entities, for example, a UPF of a CN, an AMF, or another entity such as a data control entity. For a bearer construction manner thereof, reference may be made to the NAS or GTP-U tunnel manner in the related technology, or a new manner may be defined.

In an optional embodiment, a protocol stack architecture corresponding to the data plane of the UE may use the protocol stack shown in FIG. 7, FIG. 8, or FIG. 9 as reference.

In another optional embodiment, FIG. 10 is a fourth schematic diagram of a protocol stack according to an embodiment of this application. As shown in FIG. 10, the protocol stack structure shown in FIG. 10 may be applicable to the data plane of the UE. An IoT layer and/or an IoT protocol layer (IoT in FIG. 10) may be optional. For example, an IoT protocol layer (IoT in FIG. 10) between UE and an IoT server/controller may be an independent protocol layer or a part of an APP protocol, or may be integrated into another protocol layer as a submodule; or an IoT layer may be an independent protocol layer or may be integrated into an IoT MAC layer or an IoT PHY layer as a submodule.

For example, another type of bearer of UE may be used for transmission of the requirement information or the related information of the Ambient IoT device.

For example, transmission may be performed between the first communication node and the second communication node through another type of bearer of UE.

For example, transmission may be performed between the first communication node and the third communication node through another type of bearer of UE.

In an embodiment, the another type of bearer of the UE may include a bearer type dedicated to Ambient IoT device data. For example, a dedicated entity and a pipeline mechanism are defined for IoT-related data and signaling transmission. For a bearer construction manner thereof, reference may be made to the NAS or GTP-U tunnel manner in the related technology, or a new manner may be defined.

In an optional embodiment, a protocol stack architecture corresponding to the another type of bearer manner of the UE may use the protocol stack shown in FIG. 7, FIG. 8, or FIG. 9 as reference.

In another optional embodiment, FIG. 11 is a fifth schematic diagram of a protocol stack according to an embodiment of this application. As shown in FIG. 11, the protocol stack structure shown in FIG. 11 may be applicable to the another type of bearer manner of the UE. An IoT layer and/or an IoT protocol layer (IoT in FIG. 11) may be optional. For example, an IoT protocol layer (IoT in FIG. 11) between UE and an IoT server/controller may be an independent protocol layer or a part of an APP protocol, or may be integrated into another protocol layer as a submodule; or an IoT layer may be an independent protocol layer or may be integrated into an IoT MAC layer or an IoT PHY layer as a submodule.

In this embodiment of this application, an independent protocol layer, or a submodule of an RRC protocol layer, or a submodule of an interface protocol layer, or a submodule of an APP protocol layer, or a submodule of a first protocol layer (for example, a newly defined submodule) is provided for communication between the first communication node and an upper-layer node (the second communication node and/or the third communication node). In this way, a transmission requirement of related signaling and reporting of the Ambient IoT device is met, and impact on another communication process can be avoided.

For example, in a case that the first communication node includes a network node, the related information is carried in at least one of the following:
an N2/NG signaling bearer, a UP bearer of a network node, a data plane of a network node, a management plane, a PDU session, a GTP-U tunnel, and a second bearer, where
the second bearer is different from the N2/NG signaling bearer, the UP bearer of the network node, the data plane of the network node, or the management plane.

In a case that the first communication node includes a network node, the first communication node may be referred to as an agent network node or an agent NW node, which may be referred to as a network node or an NW node.

For example, the network node may perform uplink and downlink transmission on Ambient IoT device data by using N2 signaling, another signaling plane bearer, a data plane bearer, a management plane bearer, or another new bearer type (for example, the second bearer).

For example, the network node may perform uplink transmission on the related information of the Ambient IoT device by using N2 signaling, another signaling plane bearer, a data plane bearer, a management plane bearer, or another new bearer type (for example, the second bearer).

For example, FIG. 12 is a schematic diagram of a system architecture in which a network node serves as an agent according to an embodiment of this application. As shown in FIG. 12, the first communication node may be a Network node (NW node), and an Ambient IoT device may communicate with a terminal through an air interface. For example, an interaction process of an RFID link in the related technology is reused or an interaction process applicable to a 3GPP air interface is used.

For example, as shown in FIG. 12, in the system architecture in which a network node serves as an agent, nodes such as a RAN node and a possible 5GC node may all belong to nodes participating in communication in a 3GPP system, and each node operates with a 3GPP communication architecture and function as a baseline.

For example, as shown in FIG. 12, in the system architecture in which a network node serves an agent, a RAN node interacts with an Ambient IoT device to deliver signaling or collect information (for example, transmission of the requirement information or the related information of the Ambient IoT device). The delivered signaling may be from the third communication node, such as an Ambient IoT server, a 5GC or another external node in a RAN, or another external control node. The RAN node may report information collected from an Ambient IoT node to these nodes. A bearer and a path of the RAN node may be reused for both delivery and reporting, and information arrives at a target node, that is, the second communication node, in a manner similar to that in an existing system.

For example, as shown in FIG. 12, in the system architecture in which a network node serves as an agent, because signaling and reporting related to the Ambient IoT device (for example, transmission of the requirement information or the related information of the Ambient IoT device) may have a special transmission requirement, an independent bearer and a dedicated transmission parameter may be configured for the Ambient IoT device. For example, when these information has a similar attribute to existing data of the RAN node, the information may be placed in a same bearer for transmission.

In this embodiment of this application, an existing bearer architecture and a transmission manner of the communication system are utilized between the first communication node and the second communication node to ensure a transmission requirement of the Ambient IoT device and avoid more complexity. This is applicable to massive Ambient IoT devices with ultra-low capabilities or ultra-low manufacturing costs, thereby further improving practicability of a data transmission processing manner of the communication system for data transmission of the Ambient IoT device.

For example, in a case that the first communication node includes a network node, the requirement information is carried in at least one of the following:
an N2/NG signaling bearer, a UP bearer of a network node, a data plane of a network node, a management plane, a PDU session, a GTP-U tunnel, and a second bearer, where
the second bearer is different from the N2/NG signaling bearer, the UP bearer of the network node, the data plane of the network node, or the management plane.

For example, the third communication node may perform downlink transmission on requirement information by using an N2 signaling bearer, another signaling plane bearer, a data plane bearer, a management plane bearer, or another new bearer type (for example, the second bearer).

For example, the network node may include a gNB, but is not limited to the gNB, or may be another network node with an air interface capability, for example, an IAB node or a DU node in a CU-DU architecture. In the embodiments of this application, an example in which the network node includes a gNB is applicable to other possible nodes. Details are not described in this embodiment of this application.

In this embodiment of this application, an existing bearer architecture and a transmission manner of the communication system are utilized between the first communication node and the third communication node to ensure a transmission requirement of the Ambient IoT device and avoid more complexity. This is applicable to massive Ambient IoT devices with ultra-low capabilities or ultra-low manufacturing costs, thereby further improving practicability of a data transmission processing manner of the communication system for data transmission of the Ambient IoT device.

For example, the first communication node communicates with the second communication node through an IoT Agent, and/or the first communication node communicates with the third communication node through an IoT Agent, where the IoT Agent is an independent protocol layer, or the IoT Agent is a submodule of an NG-AP protocol layer, or the IoT Agent is a submodule of an APP protocol layer.

For example, the network node may agent and transmit signaling and reporting of the Ambient IoT device (for example, transmission of the requirement information or the related information of the Ambient IoT device) by using the N2/NG signaling bearer.

For example, transmission may be performed between the first communication node and the third communication node through the N2/NG signaling bearer.

For example, transmission may be performed between the first communication node and the second communication node through the N2/NG signaling bearer.

For example, a dedicated N2/NG transmission pipeline may be established between the first communication node and the third communication node, and the requirement information may be placed in an N2/NG signaling container.

For example, a dedicated N2/NG transmission pipeline is established between the first communication node and the second communication node, and the related information of the Ambient IoT device may be placed in an N2/NG signaling container.

In an embodiment, the N2/NG signaling bearer is a signaling transmission pipeline between a RAN node and a core network control node such as an AMF. A dedicated N2/NG transmission pipeline is established between a gNB and the AMF. Ambient IoT signaling or content reporting (for example, the requirement information or the related information of the Ambient IoT device) may be placed in an N2/NG signaling container for transmission through N2 signaling in the related technology or new N2/NG signaling. Communication may be performed between the AMF and an Ambient IoT control node through a pre-planned path or a specified IP address.

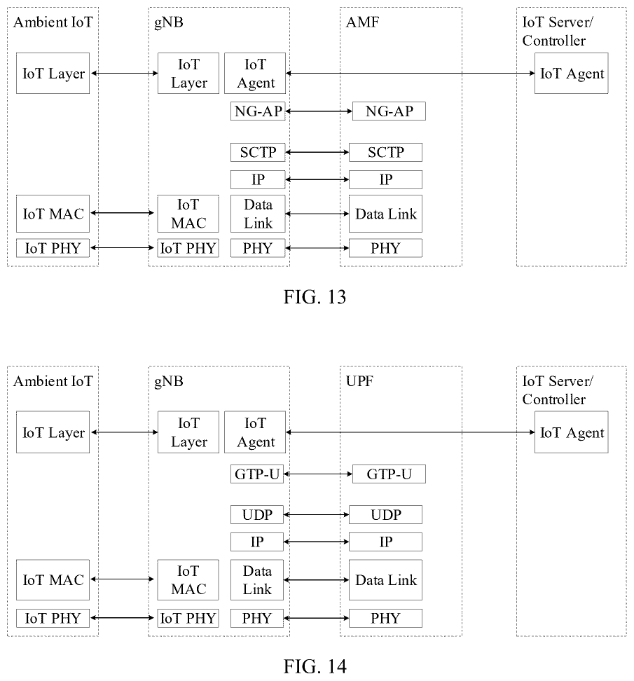

For example, FIG. 13 is a sixth schematic diagram of a protocol stack according to an embodiment of this application. As shown in FIG. 13, the protocol stack may be a protocol stack in an N2/NG signaling bearer manner. An IoT layer and/or an IoT Agent may be optional. For example, an IoT Agent between a gNB and an IoT server/controller may be an independent protocol layer or may be a part of an APP protocol, or may be integrated into an NG-AP protocol layer as a submodule; or an IoT layer may be an independent protocol layer or may be integrated into an IoT MAC layer or an IoT PHY layer as a submodule.

For example, the network node may agent and transmit signaling and reporting of the Ambient IoT device (for example, transmission of the requirement information or the related information of the Ambient IoT device) by using the UP bearer of the network node.

For example, transmission may be performed between the first communication node and the third communication node through the UP bearer of the network node.

For example, transmission may be performed between the first communication node and the second communication node through the UP bearer of the network node. For example, transmission may be performed between the first communication node and the third communication node through the PDU session and/or the GTP-U tunnel.

For example, transmission may be performed between the first communication node and the second communication node through the PDU session and/or the GTP-U tunnel.

For example, a dedicated pipeline may be established between the first communication node and the second communication node for transmission of the related information of the Ambient IoT device, or an existing UP pipeline in the related technology is reused.

For example, a dedicated pipeline may be established between the first communication node and the second communication node for transmission of the requirement information, or an existing UP pipeline in the related technology is reused.

In an embodiment, the UP bearer of the network node may be a data pipeline between a gNB and a core network user plane node such as a UPF. Transmission is carried between the gNB and the UPF through the PDU session and the GTP-U tunnel. A dedicated pipeline may be established for an IoT requirement according to a UP pipeline establishment mechanism in the related technology, or an existing UP pipeline in the related technology is reused. A transmission path and an address need to be preconfigured for data transmission between the UPF and an external control node or a server.

For example, FIG. 14 is a seventh schematic diagram of a protocol stack according to an embodiment of this application. As shown in FIG. 14, the protocol stack may be a protocol stack in a UP bearer manner of a network node. An IoT layer and/or an IoT Agent may be optional. For example, an IoT Agent between a gNB and an IoT server/controller may be an independent protocol layer or a part of an APP protocol, or may be integrated into another protocol layer as a submodule; or an IoT layer may be an independent protocol layer or may be integrated into an IoT MAC layer or an IoT PHY layer as a submodule.

For example, the network node may agent and transmit signaling and reporting of the Ambient IoT device (for example, transmission of the requirement information or the related information of the Ambient IoT device) by using the data plane of the network node or the management plane bearer.

For example, transmission may be performed between the first communication node and the third communication node through the data plane of the network node or the management plane bearer.

For example, transmission may be performed between the first communication node and the second communication node through the data plane of the network node or the management plane bearer.

For example, the data plane is a set function for emerging data collection and requirement processing, and the management plane is a function for emerging requirement management and control, and may include IoT data collection and instruction delivery (transmission of the requirement information or the related information of the Ambient IoT device).

For example, the data plane bearer or the management plane bearer may have a relatively flexible construction manner. For example, the data plane bearer or the management plane bearer may involve specific entities, for example, a UPF of a CN, an AMF, or another entity such as a data control entity. For a bearer construction manner thereof, reference may be made to the N2/NG or GTP-U tunnel manner in the related technology, or a new manner may be defined.

In an optional embodiment, a protocol stack architecture corresponding to the data plane of the network node or the management plane bearer manner may use the protocol stack shown in FIG. 13 as reference.

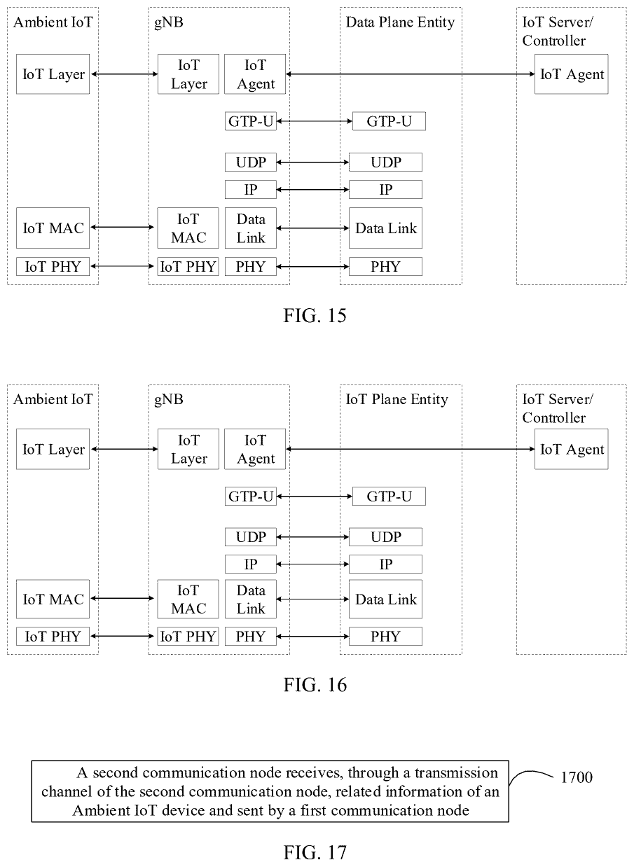

In another optional embodiment, FIG. 15 is an eighth schematic diagram of a protocol stack according to an embodiment of this application. As shown in FIG. 15, the protocol stack structure shown in FIG. 15 is applicable to the data plane or the management plane bearer manner. An IoT layer and/or an IoT Agent may be optional. For example, an IoT Agent between a gNB and an IoT server/controller may be an independent protocol layer or a part of an APP protocol, or may be integrated into another protocol layer as a submodule; or an IoT layer may be an independent protocol layer or may be integrated into an IoT MAC layer or an IoT PHY layer as a submodule.

For example, the network node may agent and transmit signaling and reporting of the Ambient IoT device (for example, transmission of the requirement information or the related information of the Ambient IoT device) by using another type of bearer of the network node.

For example, transmission may be performed between the first communication node and the third communication node through another type of bearer of the network node.

For example, transmission may be performed between the first communication node and the second communication node through another type of bearer of the network node.

For example, the another type of bearer of the network node may include a bearer type dedicated to Ambient IoT device data. A dedicated entity and a pipeline mechanism are defined for IoT-related data and signaling transmission (for example, transmission of the requirement information or the related information of the Ambient IoT device). For a bearer construction manner thereof, reference may be made to the N2/NG or GTP-U tunnel manner in the related technology, or a new manner may be defined.

In an optional embodiment, a protocol stack architecture corresponding to the another type of bearer manner of the network node may use the protocol stack shown in FIG. 14 as reference.

In another optional embodiment, FIG. 16 is a ninth schematic diagram of a protocol stack according to an embodiment of this application. As shown in FIG. 16, the protocol stack structure shown in FIG. 16 may be applicable to the another type of bearer manner of the network node. An IoT layer and/or an IoT Agent may be optional. For example, an IoT Agent between a gNB and an IoT server/controller may be an independent protocol layer or a part of an APP protocol, or may be integrated into another protocol layer as a submodule; or an IoT layer may be an independent protocol layer or may be integrated into an IoT MAC layer or an IoT PHY layer as a submodule.

For example, the network node may include a gNB, but is not limited to the gNB, or may be another network node with an air interface capability, for example, an IAB node or a DU node in a CU-DU architecture. If the network node is these network nodes in the related technology, an inter-node interface technology in the related technology may be used to replace the protocol stack structure provided in the embodiments of this application or the gNB node in the foregoing examples.

For example, the embodiments of this application are further applicable to a new network node type in a subsequent communication system. In this case, an inter-node interface may be similarly designed to implement complete gNB functions in the embodiments of this application.

For example, the requirement information includes at least one of the following:
first trigger information, where the first trigger information is used to trigger the Ambient IoT service;
a service parameter corresponding to the Ambient IoT service; and
first indication information, where the first indication information is used to indicate information that needs to be reported by the first communication node.

For example, the requirement information sent by the third communication node to the first communication node may include the first trigger information used to trigger the Ambient IoT service. The first communication node may start to execute the Ambient IoT service based on the first trigger information, for example, send the service signal to the Ambient IoT device, where the service signal is used to trigger the feedback signal, receive the feedback signal from the ambient power-enabled internet of things Ambient IoT device, and send the related information of the Ambient IoT device to the second communication node through the transmission channel of the first communication node.

For example, the requirement information may include the service parameter corresponding to the Ambient IoT service. For example, when the Ambient IoT service is an inventory service, the requirement information may include an inventory parameter.

For example, the requirement information may include the first indication information used to indicate the information that needs to be reported by the first communication node.

For example, the third communication node may require, by using the requirement information, the IoT device to perform reporting, for example, report measurement information, location information, read information (for example, temperature information fed back by an Ambient IoT device that monitors a temperature), and information about whether an operation succeeds. The first communication node may trigger an instruction as required according to a signaling indication from the third communication node.

For example, the Ambient IoT service includes inventorying a service of an Ambient IoT device within coverage of the first communication node.

For example, the first communication node sends service information to the Ambient IoT device within the coverage, and the Ambient IoT device within the coverage performs feedback. The first communication node sends the related information of the Ambient IoT device to the second communication node based on the feedback signal of the Ambient IoT device.

For example, the service parameter includes at least one of the following:
inventory scope information, where the inventory scope information is used to indicate an Ambient IoT device that needs to be inventoried by the first communication node;
an execution period of the Ambient IoT service;
an execution time of the Ambient IoT service; and
an execution condition of the Ambient IoT service.

For example, in a case that the Ambient IoT service includes inventorying a service of an Ambient IoT device within coverage of the first communication node, the service parameter may include inventory scope information, that is, indicating, to the first communication node, which or which type of Ambient IoT devices the first communication node needs to inventory.

For example, the service parameter may include an execution period of the Ambient IoT service.

For example, the Ambient IoT service is a periodic service, and the service parameter may instruct to inventory an Ambient IoT device at 20 o'clock every day, or inventory an Ambient IoT device every 5 hours. This is not limited in this embodiment of this application.

For example, the service parameter may include an execution condition of the Ambient IoT service.

For example, some execution conditions of the Ambient IoT services may be indicated or predefined. For example, the Ambient IoT service is executed in a case that 18:00 on a specified date in a specified month of a specified year arrives, or the Ambient IoT service is executed in a case that a power of a first communication node is greater than a specified threshold. This is not limited in this embodiment of this application.

For example, the inventory scope information includes at least one of the following:
a device type of the Ambient IoT device that needs to be inventoried by the first communication node;
a device list of the Ambient IoT device that needs to be inventoried by the first communication node; and
a device identifier of the Ambient IoT device that needs to be inventoried by the first communication node.

For example, the inventory scope information may include a device type of the Ambient IoT device that needs to be inventoried by the first communication node.

For example, an Ambient IoT device in a passive communication mode is inventoried.

For example, an Ambient IoT device in an active communication mode is inventoried.

For example, a desktop within a specified range is inventoried.

For example, a mouse within a specified range is inventoried.

For example, a keyboard within a specified range is inventoried.

For example, a Tag device within a specified range is inventoried.

For example, the inventory scope information may include a device list of the Ambient IoT device that needs to be inventoried by the first communication node, and the first communication node may directly inventory the Ambient IoT device in the device list.

For example, the device list may include information such as an index or an identifier of the Ambient IoT device.

For example, the inventory scope information may include a device identifier of the Ambient IoT device that needs to be inventoried by the first communication node, and the first communication node may directly inventory the Ambient IoT device indicated by the device identifier.

In this embodiment of this application, an independent protocol layer or a submodule of an NG-AP protocol layer or a submodule of an APP protocol layer is provided for communication between the first communication node and an upper-layer node (the second communication node and/or the third communication node). In this way, a transmission requirement of related signaling and reporting of the Ambient IoT device is met, and impact on another communication process can be avoided.

For example, the related information includes at least one of the following: result information obtained by executing the Ambient IoT service by the first communication node;
location information of the first communication node;
second indication information, where the second indication information is used to indicate whether the Ambient IoT service is successfully executed;
identifier information of an Ambient IoT device that sends a feedback signal;
location information of an Ambient IoT device that sends a feedback signal;
identifier information of the first communication node;
location information of the first communication node;
timestamp information corresponding to the Ambient IoT service; and
information carried in the feedback signal.

For example, after receiving the feedback signal of the Ambient IoT device, the first communication node may obtain the result information obtained by executing the Ambient IoT service.

For example, after receiving the feedback signal of the Ambient IoT device, the first communication node may generate related information of the Ambient IoT device and reported to the second communication node.

For example, when generating reporting information, the first communication node may further add some additional necessary information, such as identifier information of an IoT node, location information of an IoT node, identifier information of the first communication node, location information of the first communication node, timestamp information, indication information indicating whether an operation succeeds, and information read from an IoT device. The additional information is used for a control node to have more comprehensive reference when using the reporting information.

For example, the sending, by the first communication node, a service signal to the Ambient IoT device includes:
sending, by the first communication node, the service signal to the Ambient IoT device in a case that it is determined that a first condition is met, where
the first condition includes at least one of the following:
being within the execution period of the Ambient IoT service;
the execution time of the Ambient IoT service arrives; and
the execution condition of the Ambient IoT service is met.

For example, in a case that the requirement information indicates the execution period of the Ambient IoT service, the service signal may be sent to the Ambient IoT device upon determining that being within the execution period of the Ambient IoT service.

For example, in a case that the requirement information indicates the execution time of the Ambient IoT service, the service signal may be sent to the Ambient IoT device upon determining that being within the execution period of the Ambient IoT service.

For example, in a case that the requirement information indicates the execution condition of the Ambient IT service, the service signal may be sent to the Ambient IoT device upon determining that being within the execution period of the Ambient IoT service.

For example, in a case that the execution period of the Ambient IoT service is predefined, preset, or preconfigured, the service signal may be sent to the Ambient IoT device upon determining that being within the execution period of the Ambient IoT service.

For example, in a case that the execution time of the Ambient IoT service is predefined, preset, or preconfigured, the service signal may be sent to the Ambient IoT device upon determining that being within the execution period of the Ambient IoT service.

For example, in a case that the execution condition of the Ambient IoT service is predefined, preset, or preconfigured, the service signal may be sent to the Ambient IoT device upon determining that being within the execution period of the Ambient IoT service.

For example, the first communication node may generate a service signal based on a related requirement of the Ambient IoT service or a related execution condition, and send the service signal to the Ambient IoT device, so that feedback of the Ambient IoT device meets the requirement of the Ambient IoT service, thereby improving service quality.

For example, the receiving, by a first communication node, a feedback signal from an ambient power-enabled internet of things Ambient IoT device, and sending, by the first communication node, related information of the Ambient IoT device to a second communication node through a transmission channel of the first communication node includes at least one of the following:
receiving, by the first communication node, the feedback signal, and sending related information to the second communication node in real time; and
sending, by the first communication node, one piece of related information to the second communication node after receiving N feedback signals, where N is a positive integer.

For example, the first communication node may perform one-by-one reporting when sending the related information of the Ambient IoT device to the second communication node, thereby reducing a delay.

For example, one-by-one reporting may be applied to information that is sensitive to a delay, for example, information that needs to be immediately determined.

For example, in a case of one-by-one reporting, after receiving a feedback signal of each Ambient IoT device, the first communication node immediately generates one reporting message (including related information of the Ambient IoT device), and reports the reporting message to an upper-layer control node (for example, the second communication node) through a pipeline of the first communication node, to meet some real-time control requirements.

For example, the first communication node may perform combined reporting when sending the related information of the Ambient IoT device to the second communication node, thereby reducing information sending frequency and reducing information sending overheads.

For example, combined reporting may be applied to a scenario that is insensitive to a delay, for example, some information that does not need to be immediately determined.

For example, in a case of combined reporting, after receiving a feedback signal of one Ambient IoT device, the first communication node generally does not immediately generate a reporting message but needs to cache the feedback signal. After waiting for a specific quantity or duration, the first communication node generates integrated reporting information including collected feedback or response information of N IoT devices (including related information of the N Ambient IoT devices) when it is determined reporting information is completely collected this time, and then packages and reports the information to an upper-layer control node (for example, the second communication node) to meet an overall information requirement, thereby reducing information sending frequency and reducing information sending overheads.

For example, in a case that the first communication node is a terminal, the method further includes at least one of the following:
entering, by the first communication node, a Radio Resource Control (RRC) connected state in a case that a quantity of feedback signals received by the first communication node is greater than a quantity threshold and/or a size of the related information is greater than a size threshold; and
maintaining, by the first communication node, an RRC idle state or an RRC inactive state in a case that a quantity of feedback signals received by the first communication node is less than or equal to a quantity threshold and/or a size of the related information is less than or equal to a size threshold.

For example, if related information of a large quantity of Ambient IoT devices is to be reported, for example, a large quantity of Ambient IoT devices requiring response reporting, or a size of reported related information of Ambient IoT devices is large, or both cases exist, agent UE needs to enter a connected state for reporting. After the reporting is completed, the agent UE performs an RRC state change as required. For example, if there is no another transmission requirement, the agent UE returns to an idle state (IDLE) or an inactive state (INACTIVE).

For example, if related information of a small quantity of Ambient IoT devices is to be reported, for example, a small quantity of IoT devices requiring response reporting, or a size of reporting information is small, agent UE may remain in an idle state or an inactive state, and complete reporting once through a small data transmission related process.

For example, in an idle state, the agent UE may perform small data transmission on NAS signaling, which is similar to a process of Small Data Transmission (SDT) and Early Data Transmission (EDT). That is, Non-Access Statrum (NAS) signaling carrying IoT reporting information is reported by using a common pipeline through a Random Access Channel (RACH) process. Transmission may be carried through an SRB0 on a Uu interface, or may be carried between a gNB and an AMF through a common pipeline or a dedicated pipeline for reporting in this case, where the pipeline may be shared by a plurality of agent UEs.

For example, for agent UE in an idle state that uses a data plane or an IoT dedicated plane for reporting, when these planes have a default configuration and have no special security requirement, the UE in an idle state may perform small data transmission, which is similar to a process of Small Data Transmission (SDT) and Early Data Transmission (EDT). That is, data plane or IoT dedicated plane data carrying IoT reporting information is reported by using a common pipeline through a Random Access Channel (RACH) process. Transmission may be carried through an SRB0 on a Uu interface, or may be carried between a gNB and a core network node through a common pipeline or a dedicated pipeline for reporting in this case, where the pipeline may be shared by a plurality of agent UEs.

For example, for agent UE is in an inactive state, because the UE in an inactive state may perform NAS signaling, RRC signaling, DRB, user plane RB, and IoT dedicated RB transmission through a small data transmission process (similar to SDT: Small Data Transmission and EDT: Early Data Transmission processes). That is, data carrying information is sent to a gNB on an air interface through a RACH process, and a pipeline and a path between the gNB and a core network node (an AMF or a UPF, or even a new node) are maintained for the inactive UE. Therefore, normal transmission may be performed between the gNB and the core network node.

For an agent network node, because there are no problems such as state migration and power saving, a path between the agent network node and an upper-layer IoT control node may be always maintained, or established and deleted as required.

In this embodiment of this application, after receiving a feedback signal from an ambient power-enabled internet of things Ambient IoT device, a first communication node sends related information of the Ambient IoT device to a second communication node through a transmission channel of the first communication node. In this way, a bearer architecture and a transmission manner of a communication system can be greatly utilized, and a special transmission attribute configuration guarantee can be provided for the Ambient IoT device, to ensure a transmission requirement of the Ambient IoT device and avoid more complexity. This is applicable to massive Ambient IoT devices with ultra-low capabilities or ultra-low manufacturing costs, thereby improving practicability of a data transmission processing manner of the communication system for data transmission of the Ambient IoT device.

FIG. 17 is a second schematic flowchart of a transmission method according to an embodiment of this application. As shown in FIG. 17, the method includes the following procedures:
1700. A second communication node receives, through a transmission channel of the second communication node, related information of an Ambient IoT device and sent by a first communication node.

For example, the second communication node may be an upper-layer node compared with the first communication node.

For example, the second communication node may be a base station.

For example, the second communication node may be a core network node.

For example, the second communication node may be an IoT server.

For example, the second communication node may be another external node.

For example, the related information of the Ambient IoT device may include Ambient IoT device information, IoT service signaling, or the like.

For example, the related information of the Ambient IoT device may include any information or signaling related to an IoT service, or any combination of information or signaling.

For example, the first communication node may be a node in a communication system.

For example, the first communication node may be a terminal.

For example, the first communication node may be a network node.

For example, the first communication node may be a base station (generation NodeB, gNB), or may be another network node with an air interface capability, for example, an integrated access and backhaul (IAB) node, or a DU node in a Centralized Unit (CU)-Distributed Unit (DU) architecture.

For example, the first communication node may exist as a reader in an Ambient IoT system structure.

For example, the Ambient IoT device may provide a feedback signal for the first communication node through back scattering or active communication. The first communication node may send the related information of the Ambient IoT device to the second communication node through a transmission pipeline of the first communication node, and the second communication node may receive, through the transmission channel of the second communication node, the related information of the Ambient IoT device and sent by the first communication node.

For example, the Ambient IoT device may provide a feedback signal for the first communication node through back scattering or active communication. The first communication node may send the related information of the Ambient IoT device to the second communication node through a transmission pipeline of the first communication node, and the second communication node may receive, through the transmission channel of the first communication node and/or the second communication node, the related information of the Ambient IoT device and sent by the first communication node.

For example, the feedback signal may be sent by the Ambient IoT device.

For example, the feedback signal may be a signal that is reflected back to the first communication node by the Ambient IoT device after the first communication node sends a service signal.

For example, the feedback signal may be transmitted based on a normal operation communication mode of the Ambient IoT device.

For example, the feedback signal may be transmitted based on an active transmit communication mode of the Ambient IoT device.

For example, the feedback signal may be transmitted based on a passive transmit communication mode of the Ambient IoT device.

In an embodiment, as shown in FIG. 5, the reader may be the first communication node, for example, a handheld terminal, or may be a fixedly deployed or mobile deployed read-write device unit. The Ambient IoT device may be a terminal device based on passive communication or a terminal device based on active communication.

For example, communication between the reader and the Ambient IoT device may be based on a backward scattering communication mechanism, or may be based on an active communication manner in which the Ambient IoT device generates a transmit wave.

For example, if the first communication node is a terminal and the second communication node is a base station, the first communication node may transmit the related information of the Ambient IoT device by using an existing bearer between the terminal and the base station.

For example, the first communication node may directly communicate with massive Ambient IoT devices to complete signaling or signal delivery (for example, delivery of a service signal), and/or collect feedback and reporting information (for example, reporting of a feedback signal) from the Ambient IoT device.

For example, the first communication node may collect and report Ambient IoT device signaling or information or IoT service information or signaling by using a bearer of the first communication node to complete transmission.

For example, the transmission method provided in the embodiments of this application may be applicable to an Ambient IoT device that has no battery or power storage function, or may be applicable to an Ambient IoT device that has a battery or a power storage function.

For example, the transmission method provided in the embodiments of this application may be extended to Ambient IoT transmission requirements in 4G-LTE, 5G-NR, and a future 6G system. A specific implementation is similar, and details are not described herein again.

For example, in a communication system, when a reader-based Ambient IoT device system is used and the first communication node serves as a reader, uplink data collection and downlink signaling processes of the Ambient IoT device may be agented, and transmission may be performed through its pipeline. In this way, an existing bearer architecture and a transmission manner of the communication system can be greatly utilized, and a special transmission attribute configuration guarantee can be provided for the Ambient IoT device, to ensure a transmission requirement of the Ambient IoT device and avoid more complexity to a network, thereby accelerating rapid landing and deployment application of an Ambient IoT technology.

For example, in a case that the first communication node includes a terminal, the related information is carried in at least one of the following:
UE NAS signaling, an SRB2, UE RRC signaling, an SRB1, a UP bearer of UE, a DRB, a data plane of UE, a bearer dedicated to Ambient IoT device data, and a first bearer, where
the first bearer is different from the SRB1, the SRB2, or the DRB.

In a case that the first communication node includes a terminal, the terminal may be referred to as agent UE or an agent terminal, which may be referred to as UE or a terminal for short.

For example, the UE may perform uplink transmission on the related information of the Ambient IoT device by using NAS signaling, RRC signaling, a user plane bearer, a data plane bearer, or a new bearer type (for example, the first bearer).

In this embodiment of this application, an existing bearer architecture and a transmission manner of the communication system are utilized between the first communication node and the second communication node to ensure a transmission requirement of the Ambient IoT device and avoid more complexity. This is applicable to massive Ambient IoT devices with ultra-low capabilities or ultra-low manufacturing costs, thereby further improving practicability of a data transmission processing manner of the communication system for data transmission of the Ambient IoT device.

For example, the first communication node communicates with the second communication node through an IoT Agent, where the IoT Agent is an independent protocol layer, or the IoT Agent is a submodule of a NAS protocol layer.

For example, the UE NAS signaling is a signaling transmission pipeline between the first communication node and the second communication node such as an AMF. Transmission is performed between the first communication node and the second communication node through the SRB2.

For example, the first communication node is a terminal, the second communication node is a core network control node, and the UE NAS signaling is a signaling transmission pipeline between the UE and the core network control node such as an AMF. Transmission may be performed between UE and a gNB through the SRB2.

For example, in a case that the first communication node includes a terminal, the related information may be carried in the UE NAS signaling for transmission.

For example, in a case that the first communication node includes a terminal, the related information may be carried in a signaling transmission pipeline between UE and a core network control node for transmission.

For example, in a case that the first communication node includes a terminal, the related information may be carried in the SRB2 for transmission.

For example, the related information of the Ambient IoT device may be transmitted by using a new SRB different from the SRB2, so that different transmission priorities can be configured for the existing SRB2 and the new SRB. This avoids resource contention with existing NAS in a case that there is more related information of the Ambient IoT device.

For example, in a case that the first communication node includes a terminal, a dedicated transmission pipeline may be established between the first communication node and the second communication node, and the related information of the Ambient IoT device may be placed in a NAS signaling container for transmission by using NAS signaling in the related technology or new NAS signaling.

For example, in a case that the first communication node includes a terminal, communication may be performed between the second communication node and an Ambient IoT control node through a pre-planned path or a specified IP address.

In an embodiment, a dedicated transmission pipeline may be established between a gNB and an AMF, and the related information of the Ambient IoT device may be placed in a NAS signaling container for transmission by using existing NAS signaling or new NAS signaling. Communication may be performed between an AMF and an Ambient IoT control node through a pre-planned path or a specified IP address.

FIG. 7 is a first schematic diagram of a protocol stack according to an embodiment of this application. As shown in FIG. 7, an IoT layer and/or an IoT Agent may be optional. For example, an IoT agent may be an independent protocol layer or may be integrated into a NAS protocol stack as a submodule, or an IoT layer may be an independent protocol layer or may be integrated into an IoT MAC layer or an IoT PHY layer as a submodule.

In this embodiment of this application, an independent protocol layer or a submodule of a NAS protocol layer is provided for communication between the first communication node and an upper-layer node (the second communication node). In this way, a transmission requirement of related signaling and reporting of the Ambient IoT device is met, and impact on another communication process can be avoided.

For example, the first communication node communicates with the second communication node through an IoT protocol layer, where the IoT protocol layer is an independent protocol layer, or the IoT protocol layer is a submodule of an RRC protocol layer, or the IoT protocol layer is a submodule of an interface protocol layer, or the IoT protocol layer is a submodule of an APP protocol layer, or the IoT protocol layer is a submodule of a first protocol layer, where the first protocol layer is different from the RRC protocol layer, the interface protocol layer, or the APP protocol layer.

For example, in a case that the first communication node includes a terminal, the UE RRC signaling is a signaling transmission pipeline between the first communication node and the second communication node.

For example, the first communication node is UE, the second communication node is a gNB control node, and the UE RRC signaling is a signaling transmission pipeline between the UE and the gNB control node such as a CU.

For example, transmission may be performed between the first communication node and the second communication node through the SRB1.

In an embodiment, transmission may be performed between gNBs through the SRB1. RRC signaling generally terminates at a gNB. If the RRC signaling needs to reach another node, a transmission path and an address may be preconfigured between the gNB and the another node.

For example, the related information may be carried in a signaling transmission pipeline between the first communication node and the second communication node for transmission.

For example, the related information may be carried in a signaling transmission pipeline between the first communication node and the third communication node.

For example, the related information may be carried in a signaling transmission pipeline transmission between UE and a gNB control node.

For example, the related information may be carried in a signaling transmission pipeline between UE and a CU.

For example, the related information may be transmitted through the SRB1.

For example, FIG. 8 is a second schematic diagram of a protocol stack according to an embodiment of this application. As shown in FIG. 8, the protocol stack may be a protocol stack in an RRC signaling bearer manner. An IoT layer and/or an IoT protocol layer (IoT in FIG. 8) may be optional. For example, an IoT protocol layer (IoT in FIG. 8) between UE and a gNB may be an independent protocol layer or may be integrated into an RRC protocol stack as a submodule; or an IoT protocol layer (IoT in FIG. 8) between a gNB and an IoT server/controller may be an independent protocol layer or may be a part of an APP protocol, or may be integrated into an interface protocol layer as a submodule; or an IoT layer may be an independent protocol layer or may be integrated into an IoT MAC layer or an IoT PHY layer as a submodule.

For example, to distinguish RRC signaling transmission between UE and a base station in the related technology, a new SRB may be defined for transmission of the related information of the Ambient IoT device.

For example, the UP bearer of the UE may be used for transmission of the related information of the Ambient IoT device.

For example, the UP bearer of the UE may be a data pipeline between the first communication node and the second communication node.

For example, transmission between the first communication node and the second communication node may be carried through the DRB.

For example, transmission between the first communication node and the second communication node may be carried through the PDU session and/or the GTP-U tunnel.

For example, a dedicated pipeline may be established between the first communication node and the second communication node for an IoT requirement, or a UP pipeline in the related technology may be reused.

In an embodiment, the UP bearer of the UE is a data pipeline between the UE and a core network user plane node such as a UPF. Transmission is carried between the UE and a gNB through the DRB and is carried between the gNB and the UPF through the PDU session and the GTP-U tunnel. A dedicated pipeline may be established for an IoT requirement according to a UP pipeline establishment mechanism in the related technology, or a UP pipeline in the related technology is reused. A transmission path and an address need to be preconfigured for data transmission between the UPF and an external control node or a server.

For example, as shown in FIG. 9, the protocol stack may be a protocol stack in a UP bearer manner. An IoT layer and/or an IoT protocol layer (IoT in FIG. 9) may be optional. For example, an IoT protocol layer (IoT in FIG. 9) between UE and an IoT server/controller may be an independent protocol layer or a part of an APP protocol, or may be integrated into another protocol layer as a submodule; or an IoT layer may be an independent protocol layer or may be integrated into an IoT MAC layer or an IoT PHY layer as a submodule.

For example, the data plane of the UE may be used for transmission of the related information of the Ambient IoT device.

For example, transmission may be performed between the first communication node and the second communication node through the data plane of the UE.

In an embodiment, the data plane of the UE is used. The data plane is a set function for emerging data collection and requirement processing, and may include IoT data collection and instruction delivery (the related information of the Ambient IoT device).

For example, the data plane bearer may have a relatively flexible construction manner. For example, the data plane bearer may involve specific entities, for example, a UPF of a CN, an AMF, or another entity such as a data control entity. For a bearer construction manner thereof, reference may be made to the NAS or GTP-U tunnel manner in the related technology, or a new manner may be defined.

In an optional embodiment, a protocol stack architecture corresponding to the data plane of the UE may use the protocol stack shown in FIG. 7, FIG. 8, or FIG. 9 as reference.

In another optional embodiment, as shown in FIG. 10, the protocol stack structure shown in FIG. 10 may be applicable to the data plane of the UE. An IoT layer and/or an IoT protocol layer (IoT in FIG. 10) may be optional. For example, an IoT protocol layer (IoT in FIG. 10) between UE and an IoT server/controller may be an independent protocol layer or a part of an APP protocol, or may be integrated into another protocol layer as a submodule; or an IoT layer may be an independent protocol layer or may be integrated into an IoT MAC layer or an IoT PHY layer as a submodule.

For example, another type of bearer of UE may be used for transmission of the requirement information or the related information of the Ambient IoT device.

For example, transmission may be performed between the first communication node and the second communication node through another type of bearer of UE.

In an embodiment, the another type of bearer of the UE may include a bearer type dedicated to Ambient IoT device data. For example, a dedicated entity and a pipeline mechanism are defined for IoT-related data and signaling transmission. For a bearer construction manner thereof, reference may be made to the NAS or GTP-U tunnel manner in the related technology, or a new manner may be defined.

In an optional embodiment, a protocol stack architecture corresponding to the another type of bearer manner of the UE may use the protocol stack shown in FIG. 7, FIG. 8, or FIG. 9 as reference.

In another optional embodiment, as shown in FIG. 11, the protocol stack structure shown in FIG. 11 may be applicable to the another type of bearer manner of the UE. An IoT layer and/or an IoT protocol layer (IoT in FIG. 11) may be optional. For example, an IoT protocol layer (IoT in FIG. 11) between UE and an IoT server/controller may be an independent protocol layer or a part of an APP protocol, or may be integrated into another protocol layer as a submodule; or an IoT layer may be an independent protocol layer or may be integrated into an IoT MAC layer or an IoT PHY layer as a submodule.

In this embodiment of this application, an independent protocol layer, or a submodule of an RRC protocol layer, or a submodule of an interface protocol layer, or a submodule of an APP protocol layer, or a submodule of a first protocol layer (for example, a newly defined submodule) is provided for communication between the first communication node and an upper-layer node (the second communication node). In this way, a transmission requirement of related signaling and reporting of the Ambient IoT device is met, and impact on another communication process can be avoided.

For example, in a case that the first communication node includes a network node, the related information is carried in at least one of the following:
an N2/NG signaling bearer, a UP bearer of a network node, a data plane of a network node, a management plane, a PDU session, a GTP-U tunnel, and a second bearer, where
the second bearer is different from the N2/NG signaling bearer, the UP bearer of the network node, the data plane of the network node, or the management plane.

In a case that the first communication node includes a network node, the first communication node may be referred to as an agent network node or an agent NW node, which may be referred to as a network node or an NW node.

For example, the network node may perform uplink and downlink transmission on Ambient IoT device data by using N2 signaling, another signaling plane bearer, a data plane bearer, a management plane bearer, or another new bearer type (for example, the second bearer).

For example, the network node may perform uplink transmission on the related information of the Ambient IoT device by using N2 signaling, another signaling plane bearer, a data plane bearer, a management plane bearer, or another new bearer type (for example, the second bearer).

For example, FIG. 12 is a schematic diagram of a system architecture in which a network node serves as an agent according to an embodiment of this application. As shown in FIG. 12, the first communication node may be a Network node (NW node), and an Ambient IoT device may communicate with a terminal through an air interface. For example, an interaction process of an RFID link in the related technology is reused or an interaction process applicable to a 3GPP air interface is used.

For example, as shown in FIG. 12, in the system architecture in which a network node serves as an agent, nodes such as a RAN node and a possible 5GC node may all belong to nodes participating in communication in a 3GPP system, and each node operates with a 3GPP communication architecture and function as a baseline.

For example, as shown in FIG. 12, in the system architecture in which a network node serves an agent, a RAN node interacts with an Ambient IoT device to deliver signaling or collect information (for example, transmission of the requirement information or the related information of the Ambient IoT device). The delivered signaling may be from the third communication node, such as an Ambient IoT server, a 5GC or another external node in a RAN, or another external control node. The RAN node may report information collected from an Ambient IoT node to these nodes. A bearer and a path of the RAN node may be reused for both delivery and reporting, and information arrives at a target node, that is, the second communication node, in a manner similar to that in an existing system.

For example, as shown in FIG. 12, in the system architecture in which a network node serves as an agent, because signaling and reporting related to the Ambient IoT device (for example, transmission of the requirement information or the related information of the Ambient IoT device) may have a special transmission requirement, an independent bearer and a dedicated transmission parameter may be configured for the Ambient IoT device. For example, when these information has a similar attribute to existing data of the RAN node, the information may be placed in a same bearer for transmission.

In this embodiment of this application, an existing bearer architecture and a transmission manner of the communication system are utilized between the first communication node and the second communication node to ensure a transmission requirement of the Ambient IoT device and avoid more complexity. This is applicable to massive Ambient IoT devices with ultra-low capabilities or ultra-low manufacturing costs, thereby further improving practicability of a data transmission processing manner of the communication system for data transmission of the Ambient IoT device.

For example, the first communication node communicates with the second communication node through an IoT Agent, where the IoT Agent is an independent protocol layer, or the IoT Agent is a submodule of an NG-AP protocol layer, or the IoT Agent is a submodule of an APP protocol layer.

For example, the network node may agent and transmit signaling and reporting of the Ambient IoT device (for example, transmission of the requirement information or the related information of the Ambient IoT device) by using the N2/NG signaling bearer.

For example, transmission may be performed between the first communication node and the second communication node through the N2/NG signaling bearer.

For example, a dedicated N2/NG transmission pipeline is established between the first communication node and the second communication node, and the related information of the Ambient IoT device may be placed in an N2/NG signaling container.

In an embodiment, the N2/NG signaling bearer is a signaling transmission pipeline between a RAN node and a core network control node such as an AMF. A dedicated N2/NG transmission pipeline is established between a gNB and the AMF. Ambient IoT signaling or content reporting (for example, the requirement information or the related information of the Ambient IoT device) may be placed in an N2/NG signaling container for transmission through N2 signaling in the related technology or new N2/NG signaling. Communication may be performed between the AMF and an Ambient IoT control node through a pre-planned path or a specified IP address.

For example, as shown in FIG. 13, the protocol stack may be a protocol stack in an N2/NG signaling bearer manner. An IoT layer and/or an IoT Agent may be optional. For example, an IoT Agent between a gNB and an IoT server/controller may be an independent protocol layer or may be a part of an APP protocol, or may be integrated into an NG-AP protocol layer as a submodule; or an IoT layer may be an independent protocol layer or may be integrated into an IoT MAC layer or an IoT PHY layer as a submodule.

For example, the network node may agent and transmit signaling and reporting of the Ambient IoT device (for example, transmission of the requirement information or the related information of the Ambient IoT device) by using the UP bearer of the network node.

For example, transmission may be performed between the first communication node and the second communication node through the UP bearer of the network node.

For example, transmission may be performed between the first communication node and the second communication node through the PDU session and/or the GTP-U tunnel.

For example, a dedicated pipeline may be established between the first communication node and the second communication node for transmission of the related information of the Ambient IoT device, or an existing UP pipeline in the related technology is reused.

For example, a dedicated pipeline may be established between the first communication node and the second communication node for transmission of the requirement information, or an existing UP pipeline in the related technology is reused.

In an embodiment, the UP bearer of the network node may be a data pipeline between a gNB and a core network user plane node such as a UPF. Transmission is carried between the gNB and the UPF through the PDU session and the GTP-U tunnel. A dedicated pipeline may be established for an IoT requirement according to a UP pipeline establishment mechanism in the related technology, or an existing UP pipeline in the related technology is reused. A transmission path and an address need to be preconfigured for data transmission between the UPF and an external control node or a server.

For example, FIG. 14 is a seventh schematic diagram of a protocol stack according to an embodiment of this application. As shown in FIG. 14, the protocol stack may be a protocol stack in a UP bearer manner of a network node. An IoT layer and/or an IoT Agent may be optional. For example, an IoT Agent between a gNB and an IoT server/controller may be an independent protocol layer or a part of an APP protocol, or may be integrated into another protocol layer as a submodule; or an IoT layer may be an independent protocol layer or may be integrated into an IoT MAC layer or an IoT PHY layer as a submodule.

For example, the network node may agent and transmit signaling and reporting of the Ambient IoT device (for example, transmission of the related information of the Ambient IoT device) by using the data plane of the network node or the management plane bearer.

For example, transmission may be performed between the first communication node and the second communication node through the data plane of the network node or the management plane bearer.

For example, the data plane is a set function for emerging data collection and requirement processing, and the management plane is a function for emerging requirement management and control, and may include IoT data collection and instruction delivery (transmission of the requirement information or the related information of the Ambient IoT device).

For example, the data plane bearer or the management plane bearer may have a relatively flexible construction manner. For example, the data plane bearer or the management plane bearer may involve specific entities, for example, a UPF of a CN, an AMF, or another entity such as a data control entity. For a bearer construction manner thereof, reference may be made to the N2/NG or GTP-U tunnel manner in the related technology, or a new manner may be defined.

In an optional embodiment, a protocol stack architecture corresponding to the data plane of the network node or the management plane bearer manner may use the protocol stack shown in FIG. 13 as reference.

In another optional embodiment, as shown in FIG. 15, the protocol stack structure shown in FIG. 15 is applicable to the data plane or the management plane bearer manner. An IoT layer and/or an IoT Agent may be optional. For example, an IoT Agent between a gNB and an IoT server/controller may be an independent protocol layer or a part of an APP protocol, or may be integrated into another protocol layer as a submodule; or an IoT layer may be an independent protocol layer or may be integrated into an IoT MAC layer or an IoT PHY layer as a submodule. For example, the network node may agent and transmit signaling and reporting of the Ambient IoT device (for example, transmission of the requirement information or the related information of the Ambient IoT device) by using another type of bearer of the network node.

For example, transmission may be performed between the first communication node and the second communication node through another type of bearer of the network node.

For example, the another type of bearer of the network node may include a bearer type dedicated to Ambient IoT device data. A dedicated entity and a pipeline mechanism are defined for IoT-related data and signaling transmission (for example, transmission of the requirement information or the related information of the Ambient IoT device). For a bearer construction manner thereof, reference may be made to the N2/NG or GTP-U tunnel manner in the related technology, or a new manner may be defined.

In an optional embodiment, a protocol stack architecture corresponding to the another type of bearer manner of the network node may use the protocol stack shown in FIG. 14 as reference.

In another optional embodiment, as shown in FIG. 16, the protocol stack structure shown in FIG. 16 may be applicable to the another type of bearer manner of the network node. An IoT layer and/or an IoT Agent may be optional. For example, an IoT Agent between a gNB and an IoT server/controller may be an independent protocol layer or a part of an APP protocol, or may be integrated into another protocol layer as a submodule; or an IoT layer may be an independent protocol layer or may be integrated into an IoT MAC layer or an IoT PHY layer as a submodule.

For example, the network node may include a gNB, but is not limited to the gNB, or may be another network node with an air interface capability, for example, an IAB node or a DU node in a CU-DU architecture. If the network node is these network nodes in the related technology, an inter-node interface technology in the related technology may be used to replace the protocol stack structure provided in the embodiments of this application or the gNB node in the foregoing examples.

For example, the embodiments of this application are further applicable to a new network node type in a subsequent communication system. In this case, an inter-node interface may be similarly designed to implement complete gNB functions in the embodiments of this application.

For example, the Ambient IoT service includes inventorying a service of an Ambient IoT device within coverage of the first communication node.

For example, the first communication node sends service information to the Ambient IoT device within the coverage, and the Ambient IoT device within the coverage performs feedback. The first communication node sends the related information of the Ambient IoT device to the second communication node based on the feedback signal of the Ambient IoT device.

For example, the related information includes at least one of the following:
result information obtained by executing the Ambient IoT service by the first communication node;
location information of the first communication node;
second indication information, where the second indication information is used to indicate whether the Ambient IoT service is successfully executed;
identifier information of an Ambient IoT device that sends a feedback signal;
location information of an Ambient IoT device that sends a feedback signal;
identifier information of the first communication node;
location information of the first communication node;
timestamp information corresponding to the Ambient IoT service; and
information carried in the feedback signal.

For example, after receiving the feedback signal of the Ambient IoT device, the first communication node may obtain the result information obtained by executing the Ambient IoT service.

For example, after receiving the feedback signal from the Ambient IoT device, the first communication node may generate related information of the Ambient IoT device and reported to the second communication node, and the second communication node may receive the related information.

For example, when generating reporting information, the first communication node may further add some additional necessary information, such as identifier information of an IoT node, location information of an IoT node, identifier information of the first communication node, location information of the first communication node, timestamp information, indication information indicating whether an operation succeeds, and information read from an IoT device. The additional information is used for a control node to have more comprehensive reference when using the reporting information.

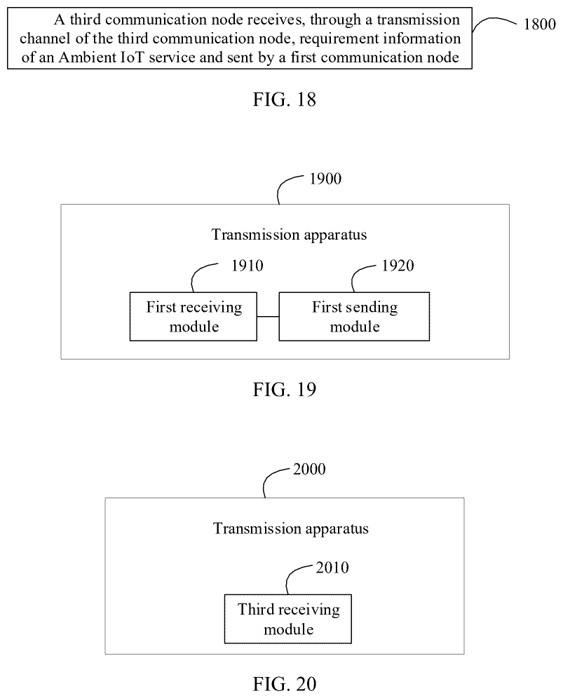

FIG. 18 is a third schematic flowchart of a transmission method according to an embodiment of this application. As shown in FIG. 18, the method includes the following procedures:
1800. A third communication node receives, through a transmission channel of the third communication node, requirement information of an Ambient IoT service and sent by a first communication node.

For example, the third communication node may be an upper-layer node compared with the first communication node.

For example, the third communication node may be a base station.

For example, the third communication node may be a core network node.

For example, the third communication node may be an IoT server.

For example, the third communication node may be another external node.

For example, the third communication node and the second communication node may be a same node.

For example, the third communication node and the second communication node may be different nodes.

For example, the first communication node serves as a transmission agent, and instruction information of the first communication node for the Ambient IoT device may be from an upper-layer node, that is, the third communication node.

For example, the third communication node may generate the requirement information of the Ambient IoT service, and send the requirement information to the first communication node through a signaling process between the third communication node and the first communication node.

In an embodiment, the requirement information may include performing reading and writing on an Ambient IoT device.

In an embodiment, the requirement information may include inventorying the Ambient IoT device.

In an embodiment, the requirement information may include positioning the Ambient IoT device.

For example, the requirement information may indicate a requirement of any IoT service, and details are not described herein.

For example, the first communication node may receive, through the transmission channel of the first communication node, the requirement information of the Ambient IoT service and sent by the third communication node.

For example, the third communication node may send the requirement information of the Ambient IoT service to the first communication node through the transmission channel of the third communication node, and the first communication node may receive the requirement information of the Ambient IoT service through the transmission channel of the first communication node.

For example, the third communication node may send the requirement information of the Ambient IoT service to the first communication node through the transmission channel of the third communication node and/or the first communication node, and the first communication node may receive the requirement information of the Ambient IoT service through the transmission channel of the first communication node.

For example, after obtaining the requirement information, the first communication node may learn a requirement of the Ambient IoT service and execute the Ambient IoT service.

For example, when executing the Ambient IoT service, the first communication node may send the service signal to the Ambient IoT device, and expect feedback from the Ambient IoT device.

For example, that the first communication node sends the service signal to the Ambient IoT device may include: the first communication node sends a radio wave to the Ambient IoT device through an IoT interface, where the radio wave transmits energy and an Ambient IoT device operation instruction (a service signal) to the Ambient IoT device, so that the Ambient IoT device transmits the feedback signal, for example, sends the feedback signal through backward scattering or performs feedback after adding information of the Ambient IoT device or delay information by using an incoming wave. The Ambient IoT device operation instruction is generally used to indicate a response of the Ambient IoT device, for example, responding to inventory information, and a parameter and a manner to be used to respond to inventory information.

For example, the Ambient IoT device receives the service signal of the first communication node, and performs feedback and response based on signal content of the service signal.

For example, for a specific method and content in which the first communication node sends the service signal to the Ambient IoT device and performs feedback and response (that is, transmits the feedback signal) on the Ambient IoT device, reference may be made to behavior of RFID, or a new process may be designed based on RFID to adapt to the 3GPP system. This is not limited in this embodiment of this application.

For example, after receiving the feedback signal of the Ambient IoT device, the first communication node may report the related information of the Ambient IoT device to an upper-layer control node (the second communication node) based on the feedback signal.

In an optional embodiment, the third communication node that sends the requirement information to the first communication node and the second communication node that reports the Ambient IoT device to the first communication node may be a same node or different nodes. For example, one control node (the third communication node) is configured to generate an instruction, and another control node (a second control node) is configured to collect and process a response and feedback information, and then feeds back a generated result to a signaling control node to form closed-loop control.

For example, the first communication node may directly communicate with the Ambient IoT device to complete signaling or signal delivery, for example, delivery of a service signal.

For example, the first communication node may directly communicate with massive Ambient IoT devices to complete signaling or signal delivery, for example, delivery of a service signal.

For example, the first communication node may communicate with the Ambient IoT device based on a normal operation communication mode of the Ambient IoT device.

For example, the first communication node may communicate with the Ambient IoT device based on an active transmit communication mode of the Ambient IoT device.

For example, the first communication node may communicate with the Ambient IoT device based on a passive transmit communication mode of the Ambient IoT device.

In this embodiment of this application, the first communication node receives, through the transmission channel of the first communication node, the requirement information sent by the third communication node, and sends the service signal to the Ambient IoT device, to implement execution of IoT based on an instruction of an upper-layer node. In addition, a bearer architecture and a transmission manner of the communication system can be utilized to ensure a transmission requirement of the Ambient IoT device and avoid more complexity. This is applicable to massive Ambient IoT devices with ultra-low capabilities or ultra-low manufacturing costs, thereby further improving practicability of a data transmission processing manner of the communication system for data transmission of the Ambient IoT device.

For example, in a case that the first communication node includes a terminal, the requirement information is carried in at least one of the following:
UE NAS signaling, an SRB2, UE RRC signaling, an SRB1, a UP bearer of UE, a DRB, a data plane of UE, a bearer dedicated to Ambient IoT device data, and a first bearer, where
the first bearer is different from the SRB1, the SRB2, or the DRB.

For example, the UE may perform downlink transmission on Ambient IoT data (for example, the requirement information) by using NAS signaling, RRC signaling, a user plane bearer, a data plane bearer, or a new bearer type.

For example, the UE may perform uplink and downlink transmission on Ambient IoT data by using NAS signaling, RRC signaling, a user plane bearer, a data plane bearer, or a new bearer type.

For example, the UE may agent and transmit signaling and reporting of the Ambient IoT device by using NAS signaling.

In this embodiment of this application, an existing bearer architecture and a transmission manner of the communication system are utilized between the first communication node and the third communication node to ensure a transmission requirement of the Ambient IoT device and avoid more complexity. This is applicable to massive Ambient IoT devices with ultra-low capabilities or ultra-low manufacturing costs, thereby further improving practicability of a data transmission processing manner of the communication system for data transmission of the Ambient IoT device.

For example, the first communication node communicates with the third communication node through an IoT Agent, where the IoT Agent is an independent protocol layer, or the IoT Agent is a submodule of a NAS protocol layer.

For example, the UE NAS signaling is a signaling transmission pipeline between the first communication node and the third communication node such as an AMF. Transmission is performed between the first communication node and the third communication node through the SRB2.

For example, the first communication node is a terminal, the third communication node is a core network control node, and the UE NAS signaling is a signaling transmission pipeline between the UE and the core network control node such as an AMF. Transmission may be performed between UE and a gNB through the SRB2.

For example, in a case that the first communication node includes a terminal, the requirement information may be carried in the UE NAS signaling for transmission.

For example, in a case that the first communication node includes a terminal, the requirement information may be carried in a signaling transmission pipeline between UE and a core network control node for transmission.

For example, in a case that the first communication node includes a terminal, the requirement information may be carried in the SRB2 for transmission.

For example, the requirement information or the related information of the Ambient IoT device may be transmitted by using a new SRB different from the SRB2, so that different transmission priorities can be configured for the existing SRB2 and the new SRB. This avoids resource contention with existing NAS in a case that there is more requirement information.

For example, in a case that the first communication node includes a terminal, a dedicated transmission pipeline may be established between the first communication node and the third communication node, and the requirement information may be placed in a NAS signaling container for transmission by using NAS signaling in the related technology or new NAS signaling.

In an embodiment, a dedicated transmission pipeline may be established between a gNB and an AMF, and the related information of the Ambient IoT device may be placed in a NAS signaling container for transmission by using existing NAS signaling or new NAS signaling. Communication may be performed between an AMF and an Ambient IoT control node through a pre-planned path or a specified IP address.

For example, in a case that the first communication node includes a terminal, a dedicated transmission pipeline may be established between the first communication node and the third communication node, and the related information of the Ambient IoT device may be placed in a NAS signaling container for transmission by using NAS signaling in the related technology or new NAS signaling.

For example, communication may be performed between the third communication node and an Ambient IoT control node through a pre-planned path or a specified IP address.

In an embodiment, a dedicated transmission pipeline may be established between a gNB and an AMF, and the requirement information may be placed in a NAS signaling container for transmission by using existing NAS signaling or new NAS signaling. Communication may be performed between an AMF and an Ambient IoT control node through a pre-planned path or a specified IP address.

As shown in FIG. 7, an IoT layer and/or an IoT Agent may be optional. For example, an IoT agent may be an independent protocol layer or may be integrated into a NAS protocol stack as a submodule, or an IoT layer may be an independent protocol layer or may be integrated into an IoT MAC layer or an IoT PHY layer as a submodule.

In this embodiment of this application, an independent protocol layer or a submodule of a NAS protocol layer is provided for communication between the first communication node and an upper-layer node (the second communication node and/or the third communication node). In this way, a transmission requirement of related signaling and reporting of the Ambient IoT device is met, and impact on another communication process can be avoided.

For example, the first communication node communicates with the third communication node through an IoT protocol layer, where the IoT protocol layer is an independent protocol layer, or the IoT protocol layer is a submodule of an RRC protocol layer, or the IoT protocol layer is a submodule of an interface protocol layer, or the IoT protocol layer is a submodule of an APP protocol layer, or the IoT protocol layer is a submodule of a first protocol layer, where the first protocol layer is different from the RRC protocol layer, the interface protocol layer, or the APP protocol layer.

For example, in a case that the first communication node includes a terminal, the UE RRC signaling is a signaling transmission pipeline between the first communication node and the third communication node.

For example, the first communication node is UE, the third communication node is a gNB control node, and the UE RRC signaling is a signaling transmission pipeline between the UE and the gNB control node such as a CU.

For example, in a case that the first communication node includes a terminal, transmission may be performed between the first communication node and the third communication node through the SRB1.

In an embodiment, transmission may be performed between gNBs through the SRB1. RRC signaling generally terminates at a gNB. If the RRC signaling needs to reach another node, a transmission path and an address may be preconfigured between the gNB and the another node.

For example, the related information or the requirement information may be carried in a signaling transmission pipeline between the first communication node and the third communication node. For example, the related information or the requirement information may be carried in a signaling transmission pipeline between UE and a gNB control node for transmission.

For example, the related information or the requirement information may be carried in a signaling transmission pipeline between UE and a CU.

For example, the related information or the requirement information may be transmitted through the SRB1.

For example, FIG. 8 is a second schematic diagram of a protocol stack according to an embodiment of this application. As shown in FIG. 8, the protocol stack may be a protocol stack in an RRC signaling bearer manner. An IoT layer and/or an IoT protocol layer (IoT in FIG. 8) may be optional. For example, an IoT protocol layer (IoT in FIG. 8) between UE and a gNB may be an independent protocol layer or may be integrated into an RRC protocol stack as a submodule; or an IoT protocol layer (IoT in FIG. 8) between a gNB and an IoT server/controller may be an independent protocol layer or may be a part of an APP protocol, or may be integrated into an interface protocol layer as a submodule; or an IoT layer may be an independent protocol layer or may be integrated into an IoT MAC layer or an IoT PHY layer as a submodule.

For example, to distinguish RRC signaling transmission between UE and a base station in the related technology, a new SRB may be defined for transmission of the requirement information or the related information of the Ambient IoT device.

For example, the UP bearer of the UE may be used for transmission of the requirement information or the related information of the Ambient IoT device.

For example, the UP bearer of the UE may be a data pipeline between the first communication node and the third communication node.

For example, transmission between the first communication node and the third communication node may be carried through the DRB.

For example, transmission between the first communication node and the third communication node may be carried through the PDU session and/or the GTP-U tunnel.

For example, a dedicated pipeline may be established between the first communication node and the third communication node for an IoT requirement, or a UP pipeline in the related technology may be reused.

In an embodiment, the UP bearer of the UE is a data pipeline between the UE and a core network user plane node such as a UPF. Transmission is carried between the UE and a gNB through the DRB and is carried between the gNB and the UPF through the PDU session and the GTP-U tunnel. A dedicated pipeline may be established for an IoT requirement according to a UP pipeline establishment mechanism in the related technology, or a UP pipeline in the related technology is reused. A transmission path and an address need to be preconfigured for data transmission between the UPF and an external control node or a server.

For example, FIG. 9 is a third schematic diagram of a protocol stack according to an embodiment of this application. As shown in FIG. 9, the protocol stack may be a protocol stack in a UP bearer manner. An IoT layer and/or an IoT protocol layer (IoT in FIG. 9) may be optional. For example, an IoT protocol layer (IoT in FIG. 9) between UE and an IoT server/controller may be an independent protocol layer or a part of an APP protocol, or may be integrated into another protocol layer as a submodule; or an IoT layer may be an independent protocol layer or may be integrated into an IoT MAC layer or an IoT PHY layer as a submodule.

For example, the data plane of the UE may be used for transmission of the requirement information.

For example, transmission may be performed between the first communication node and the third communication node through the data plane of the UE.

In an embodiment, the data plane of the UE is used. The data plane is a set function for emerging data collection and requirement processing, and may include IoT data collection and instruction delivery (the requirement information or the related information of the Ambient IoT device).

For example, the data plane bearer may have a relatively flexible construction manner. For example, the data plane bearer may involve specific entities, for example, a UPF of a CN, an AMF, or another entity such as a data control entity. For a bearer construction manner thereof, reference may be made to the NAS or GTP-U tunnel manner in the related technology, or a new manner may be defined.

In an optional embodiment, a protocol stack architecture corresponding to the data plane of the UE may use the protocol stack shown in FIG. 7, FIG. 8, or FIG. 9 as reference.

In another optional embodiment, as shown in FIG. 10, the protocol stack structure shown in FIG. 10 may be applicable to the data plane of the UE. An IoT layer and/or an IoT protocol layer (IoT in FIG. 10) may be optional. For example, an IoT protocol layer (IoT in FIG. 10) between UE and an IoT server/controller may be an independent protocol layer or a part of an APP protocol, or may be integrated into another protocol layer as a submodule; or an IoT layer may be an independent protocol layer or may be integrated into an IoT MAC layer or an IoT PHY layer as a submodule.

For example, another type of bearer of UE may be used for transmission of the requirement information or the related information of the Ambient IoT device.

For example, transmission may be performed between the first communication node and the third communication node through another type of bearer of UE.

In an embodiment, the another type of bearer of the UE may include a bearer type dedicated to Ambient IoT device data. For example, a dedicated entity and a pipeline mechanism are defined for IoT-related data and signaling transmission. For a bearer construction manner thereof, reference may be made to the NAS or GTP-U tunnel manner in the related technology, or a new manner may be defined.

In an optional embodiment, a protocol stack architecture corresponding to the another type of bearer manner of the UE may use the protocol stack shown in FIG. 7, FIG. 8, or FIG. 9 as reference.

In another optional embodiment, as shown in FIG. 11, the protocol stack structure shown in FIG. 11 may be applicable to the another type of bearer manner of the UE. An IoT layer and/or an IoT protocol layer (IoT in FIG. 11) may be optional. For example, an IoT protocol layer (IoT in FIG. 11) between UE and an IoT server/controller may be an independent protocol layer or a part of an APP protocol, or may be integrated into another protocol layer as a submodule; or an IoT layer may be an independent protocol layer or may be integrated into an IoT MAC layer or an IoT PHY layer as a submodule.

In this embodiment of this application, an independent protocol layer, or a submodule of an RRC protocol layer, or a submodule of an interface protocol layer, or a submodule of an APP protocol layer, or a submodule of a first protocol layer (for example, a newly defined submodule) is provided for communication between the first communication node and an upper-layer node (the third communication node). In this way, a transmission requirement of related signaling and reporting of the Ambient IoT device is met, and impact on another communication process can be avoided.

For example, in a case that the first communication node includes a network node, the requirement information is carried in at least one of the following:
an N2/NG signaling bearer, a UP bearer of a network node, a data plane of a network node, a management plane, a PDU session, a GTP-U tunnel, and a second bearer, where
the second bearer is different from the N2/NG signaling bearer, the UP bearer of the network node, the data plane of the network node, or the management plane.

In a case that the first communication node includes a network node, the first communication node may be referred to as an agent network node or an agent NW node, which may be referred to as a network node or an NW node.

For example, the network node may perform uplink and downlink transmission on Ambient IoT device data by using N2 signaling, another signaling plane bearer, a data plane bearer, a management plane bearer, or another new bearer type (for example, the second bearer).

For example, the network node may perform uplink transmission on the related information of the Ambient IoT device by using N2 signaling, another signaling plane bearer, a data plane bearer, a management plane bearer, or another new bearer type (for example, the second bearer).

For example, FIG. 12 is a schematic diagram of a system architecture in which a network node serves as an agent according to an embodiment of this application. As shown in FIG. 12, the first communication node may be a Network node (NW node), and an Ambient IoT device may communicate with a terminal through an air interface. For example, an interaction process of an RFID link in the related technology is reused or an interaction process applicable to a 3GPP air interface is used.

For example, as shown in FIG. 12, in the system architecture in which a network node serves as an agent, nodes such as a RAN node and a possible 5GC node may all belong to nodes participating in communication in a 3GPP system, and each node operates with a 3GPP communication architecture and function as a baseline.

For example, as shown in FIG. 12, in the system architecture in which a network node serves an agent, a RAN node interacts with an Ambient IoT device to deliver signaling or collect information (for example, transmission of the requirement information or the related information of the Ambient IoT device). The delivered signaling may be from the third communication node, such as an Ambient IoT server, a 5GC or another external node in a RAN, or another external control node. The RAN node may report information collected from an Ambient IoT node to these nodes. A bearer and a path of the RAN node may be reused for both delivery and reporting, and information arrives at a target node, that is, the second communication node, in a manner similar to that in an existing system.

For example, as shown in FIG. 12, in the system architecture in which a network node serves as an agent, because signaling and reporting related to the Ambient IoT device (for example, transmission of the requirement information or the related information of the Ambient IoT device) may have a special transmission requirement, an independent bearer and a dedicated transmission parameter may be configured for the Ambient IoT device. For example, when these information has a similar attribute to existing data of the RAN node, the information may be placed in a same bearer for transmission.

For example, the third communication node may perform downlink transmission on requirement information by using an N2 signaling bearer, another signaling plane bearer, a data plane bearer, a management plane bearer, or another new bearer type (for example, the second bearer).

For example, the network node may include a gNB, but is not limited to the gNB, or may be another network node with an air interface capability, for example, an IAB node or a DU node in a CU-DU architecture. In the embodiments of this application, an example in which the network node includes a gNB is applicable to other possible nodes. Details are not described in this embodiment of this application.

In this embodiment of this application, an existing bearer architecture and a transmission manner of the communication system are utilized between the first communication node and the third communication node to ensure a transmission requirement of the Ambient IoT device and avoid more complexity. This is applicable to massive Ambient IoT devices with ultra-low capabilities or ultra-low manufacturing costs, thereby further improving practicability of a data transmission processing manner of the communication system for data transmission of the Ambient IoT device.

For example, the first communication node communicates with the third communication node through an IoT Agent, where the IoT Agent is an independent protocol layer, or the IoT Agent is a submodule of an NG-AP protocol layer, or the IoT Agent is a submodule of an APP protocol layer.

For example, the network node may agent and transmit signaling and reporting of the Ambient IoT device (for example, transmission of the requirement information or the related information of the Ambient IoT device) by using the N2/NG signaling bearer.

For example, transmission may be performed between the first communication node and the third communication node through the N2/NG signaling bearer.

For example, a dedicated N2/NG transmission pipeline may be established between the first communication node and the third communication node, and the requirement information may be placed in an N2/NG signaling container.

In an embodiment, the N2/NG signaling bearer is a signaling transmission pipeline between a RAN node and a core network control node such as an AMF. A dedicated N2/NG transmission pipeline is established between a gNB and the AMF. Ambient IoT signaling or content reporting (for example, the requirement information or the related information of the Ambient IoT device) may be placed in an N2/NG signaling container for transmission through N2 signaling in the related technology or new N2/NG signaling. Communication may be performed between the AMF and an Ambient IoT control node through a pre-planned path or a specified IP address.

For example, FIG. 13 is a sixth schematic diagram of a protocol stack according to an embodiment of this application. As shown in FIG. 13, the protocol stack may be a protocol stack in an N2/NG signaling bearer manner. An IoT layer and/or an IoT Agent may be optional. For example, an IoT Agent between a gNB and an IoT server/controller may be an independent protocol layer or may be a part of an APP protocol, or may be integrated into an NG-AP protocol layer as a submodule; or an IoT layer may be an independent protocol layer or may be integrated into an IoT MAC layer or an IoT PHY layer as a submodule.

For example, the network node may agent and transmit signaling and reporting of the Ambient IoT device (for example, transmission of the requirement information or the related information of the Ambient IoT device) by using the UP bearer of the network node.

For example, transmission may be performed between the first communication node and the third communication node through the UP bearer of the network node.

For example, transmission may be performed between the first communication node and the third communication node through the PDU session and/or the GTP-U tunnel.

In an embodiment, the UP bearer of the network node may be a data pipeline between a gNB and a core network user plane node such as a UPF. Transmission is carried between the gNB and the UPF through the PDU session and the GTP-U tunnel. A dedicated pipeline may be established for an IoT requirement according to a UP pipeline establishment mechanism in the related technology, or an existing UP pipeline in the related technology is reused. A transmission path and an address need to be preconfigured for data transmission between the UPF and an external control node or a server.

For example, as shown in FIG. 14, the protocol stack may be a protocol stack in a UP bearer manner of a network node. An IoT layer and/or an IoT Agent may be optional. For example, an IoT Agent between a gNB and an IoT server/controller may be an independent protocol layer or a part of an APP protocol, or may be integrated into another protocol layer as a submodule; or an IoT layer may be an independent protocol layer or may be integrated into an IoT MAC layer or an IoT PHY layer as a submodule.

For example, the network node may agent and transmit signaling and reporting of the Ambient IoT device (for example, transmission of the requirement information or the related information of the Ambient IoT device) by using the data plane of the network node or the management plane bearer.

For example, transmission may be performed between the first communication node and the third communication node through the data plane of the network node or the management plane bearer.

For example, the data plane is a set function for emerging data collection and requirement processing, and the management plane is a function for emerging requirement management and control, and may include IoT data collection and instruction delivery (transmission of the requirement information or the related information of the Ambient IoT device).

For example, the data plane bearer or the management plane bearer may have a relatively flexible construction manner. For example, the data plane bearer or the management plane bearer may involve specific entities, for example, a UPF of a CN, an AMF, or another entity such as a data control entity. For a bearer construction manner thereof, reference may be made to the N2/NG or GTP-U tunnel manner in the related technology, or a new manner may be defined.

In an optional embodiment, a protocol stack architecture corresponding to the data plane of the network node or the management plane bearer manner may use the protocol stack shown in FIG. 13 as reference.

In another optional embodiment, as shown in FIG. 15, the protocol stack structure shown in FIG. 15 is applicable to the data plane or the management plane bearer manner. An IoT layer and/or an IoT Agent may be optional. For example, an IoT Agent between a gNB and an IoT server/controller may be an independent protocol layer or a part of an APP protocol, or may be integrated into another protocol layer as a submodule; or an IoT layer may be an independent protocol layer or may be integrated into an IoT MAC layer or an IoT PHY layer as a submodule.

For example, the network node may agent and transmit signaling and reporting of the Ambient IoT device (for example, transmission of the requirement information or the related information of the Ambient IoT device) by using another type of bearer of the network node.

For example, transmission may be performed between the first communication node and the third communication node through another type of bearer of the network node.

For example, the another type of bearer of the network node may include a bearer type dedicated to Ambient IoT device data. A dedicated entity and a pipeline mechanism are defined for IoT-related data and signaling transmission (for example, transmission of the requirement information or the related information of the Ambient IoT device). For a bearer construction manner thereof, reference may be made to the N2/NG or GTP-U tunnel manner in the related technology, or a new manner may be defined.

In an optional embodiment, a protocol stack architecture corresponding to the another type of bearer manner of the network node may use the protocol stack shown in FIG. 14 as reference.

In another optional embodiment, as shown in FIG. 16, the protocol stack structure shown in FIG. 16 may be applicable to the another type of bearer manner of the network node. An IoT layer and/or an IoT Agent may be optional. For example, an IoT Agent between a gNB and an IoT server/controller may be an independent protocol layer or a part of an APP protocol, or may be integrated into another protocol layer as a submodule; or an IoT layer may be an independent protocol layer or may be integrated into an IoT MAC layer or an IoT PHY layer as a submodule.

For example, the network node may include a gNB, but is not limited to the gNB, or may be another network node with an air interface capability, for example, an IAB node or a DU node in a CU-DU architecture. If the network node is these network nodes in the related technology, an inter-node interface technology in the related technology may be used to replace the protocol stack structure provided in the embodiments of this application or the gNB node in the foregoing examples.

For example, the embodiments of this application are further applicable to a new network node type in a subsequent communication system. In this case, an inter-node interface may be similarly designed to implement complete gNB functions in the embodiments of this application.

For example, the requirement information sent by the third communication node to the first communication node may include the first trigger information used to trigger the Ambient IoT service. The first communication node may start to execute the Ambient IoT service based on the first trigger information, for example, send the service signal to the Ambient IoT device, where the service signal is used to trigger the feedback signal, receive the feedback signal from the ambient power-enabled internet of things Ambient IoT device, and send the related information of the Ambient IoT device to the second communication node through the transmission channel of the first communication node.

For example, the requirement information may include the service parameter corresponding to the Ambient IoT service. For example, when the Ambient IoT service is an inventory service, the requirement information may include an inventory parameter.

For example, the requirement information may include the first indication information used to indicate the information that needs to be reported by the first communication node.

For example, the third communication node may require, by using the requirement information, the IoT device to perform reporting, for example, report measurement information, location information, read information (for example, temperature information fed back by an Ambient IoT device that monitors a temperature), and information about whether an operation succeeds. The first communication node may trigger an instruction as required according to a signaling indication from the third communication node.

For example, the Ambient IoT service includes inventorying a service of an Ambient IoT device within coverage of the first communication node.

For example, the first communication node sends service information to the Ambient IoT device within the coverage, and the Ambient IoT device within the coverage performs feedback. The first communication node sends the related information of the Ambient IoT device to the second communication node based on the feedback signal of the Ambient IoT device.

For example, the service parameter includes at least one of the following:
inventory scope information, where the inventory scope information is used to indicate an Ambient IoT device that needs to be inventoried by the first communication node;
an execution period of the Ambient IoT service;
an execution time of the Ambient IoT service; and
an execution condition of the Ambient IoT service.

For example, in a case that the Ambient IoT service includes inventorying a service of an Ambient IoT device within coverage of the first communication node, the service parameter may include inventory scope information, that is, indicating, to the first communication node, which or which type of Ambient IoT devices the first communication node needs to inventory.

For example, the service parameter may include an execution period of the Ambient IoT service.

For example, the Ambient IoT service is a periodic service, and the service parameter may instruct to inventory an Ambient IoT device at 20 o'clock every day, or inventory an Ambient IoT device every 5 hours. This is not limited in this embodiment of this application.

For example, the service parameter may include an execution condition of the Ambient IoT service.

For example, some execution conditions of the Ambient IoT services may be indicated or predefined. For example, the Ambient IoT service is executed in a case that 18:00 on a specified date in a specified month of a specified year arrives, or the Ambient IoT service is executed in a case that a power of a first communication node is greater than a specified threshold. This is not limited in this embodiment of this application.

For example, the inventory scope information includes at least one of the following: a device type of the Ambient IoT device that needs to be inventoried by the first communication node;
a device list of the Ambient IoT device that needs to be inventoried by the first communication node; and
a device identifier of the Ambient IoT device that needs to be inventoried by the first communication node.

For example, the inventory scope information may include a device type of the Ambient IoT device that needs to be inventoried by the first communication node.

For example, an Ambient IoT device in a passive communication mode is inventoried.

For example, an Ambient IoT device in an active communication mode is inventoried.

For example, a desktop within a specified range is inventoried.

For example, a mouse within a specified range is inventoried.

For example, a keyboard within a specified range is inventoried.

For example, a Tag device within a specified range is inventoried.

For example, the inventory scope information may include a device list of the Ambient IoT device that needs to be inventoried by the first communication node, and the first communication node may directly inventory the Ambient IoT device in the device list.

For example, the device list may include information such as an index or an identifier of the Ambient IoT device.

For example, the inventory scope information may include a device identifier of the Ambient IoT device that needs to be inventoried by the first communication node, and the first communication node may directly inventory the Ambient IoT device indicated by the device identifier.

In this embodiment of this application, an independent protocol layer or a submodule of an NG-AP protocol layer or a submodule of an APP protocol layer is provided for communication between the first communication node and an upper-layer node (the second communication node and/or the third communication node). In this way, a transmission requirement of related signaling and reporting of the Ambient IoT device is met, and impact on another communication process can be avoided.

The transmission method provided in the embodiments of this application may be executed by a transmission apparatus. In the embodiments of this application, an example in which the transmission apparatus executes the transmission method is used to describe the transmission apparatus provided in the embodiments of this application.

FIG. 19 is a first schematic structural diagram of a transmission apparatus according to an embodiment of this application. As shown in FIG. 19, the apparatus 1900 includes:
a first receiving module 1910, configured to receive a feedback signal from an ambient power-enabled internet of things Ambient IoT device; and
a first sending module 1920, configured to send related information of the Ambient IoT device to a second communication node through a transmission channel of the first communication node.

In this embodiment of this application, after receiving a feedback signal from an ambient power-enabled internet of things Ambient IoT device, a first communication node sends related information of the Ambient IoT device to a second communication node through a transmission channel of the first communication node. In this way, a bearer architecture and a transmission manner of a communication system can be greatly utilized, and a special transmission attribute configuration guarantee can be provided for the Ambient IoT device, to ensure a transmission requirement of the Ambient IoT device and avoid more complexity. This is applicable to massive Ambient IoT devices with ultra-low capabilities or ultra-low manufacturing costs, thereby improving practicability of a data transmission processing manner of the communication system for data transmission of the Ambient IoT device.

For example, the apparatus further includes at least one of the following:
a second receiving module, configured to: before the first communication node receives the feedback signal from the Ambient IoT device, receive, through the transmission channel, requirement information of an Ambient IoT service and sent by a third communication node; and
a second sending module, configured to send a service signal to the Ambient IoT device, where the service signal is used to trigger the feedback signal.

For example, the first communication node communicates with the Ambient IoT device through an IoT layer, where the IoT layer is an independent protocol layer, or the IoT layer is a submodule of an IoT MAC layer or an IoT PHY layer.

For example, in a case that the first communication node includes a terminal, the related information is carried in at least one of the following:
UE NAS signaling, an SRB2, UE RRC signaling, an SRB1, a UP bearer of UE, a DRB, a data plane of UE, a bearer dedicated to Ambient IoT device data, and a first bearer, where
the first bearer is different from the SRB1, the SRB2, or the DRB.

For example, in a case that the first communication node includes a terminal, the requirement information is carried in at least one of the following:
UE NAS signaling, an SRB2, UE RRC signaling, an SRB1, a UP bearer of UE, a DRB, a data plane of UE, a bearer dedicated to Ambient IoT device data, and a first bearer, where
the first bearer is different from the SRB1, the SRB2, or the DRB.

For example, the first communication node communicates with the second communication node through an IoT Agent, and/or the first communication node communicates with the third communication node through an IoT Agent, where the IoT Agent is an independent protocol layer, or the IoT Agent is a submodule of a NAS protocol layer.

For example, the first communication node communicates with the second communication node through an IoT protocol layer, and/or the first communication node communicates with the third communication node through an IoT protocol layer, where the IoT protocol layer is an independent protocol layer, or the IoT protocol layer is a submodule of an RRC protocol layer, or the IoT protocol layer is a submodule of an interface protocol layer, or the IoT protocol layer is a submodule of an APP protocol layer, or the IoT protocol layer is a submodule of a first protocol layer, where the first protocol layer is different from the RRC protocol layer, the interface protocol layer, or the APP protocol layer.

For example, in a case that the first communication node includes a network node, the related information is carried in at least one of the following:
an N2/NG signaling bearer, a UP bearer of a network node, a data plane of a network node, a management plane, a PDU session, a GTP-U tunnel, and a second bearer, where
the second bearer is different from the N2/NG signaling bearer, the UP bearer of the network node, the data plane of the network node, or the management plane.

For example, in a case that the first communication node includes a network node, the requirement information is carried in at least one of the following:
an N2/NG signaling bearer, a UP bearer of a network node, a data plane of a network node, a management plane, a PDU session, a GTP-U tunnel, and a second bearer, where
the second bearer is different from the N2/NG signaling bearer, the UP bearer of the network node, the data plane of the network node, or the management plane.

For example, the first communication node communicates with the second communication node through an IoT Agent, and/or the first communication node communicates with the third communication node through an IoT Agent, where the IoT Agent is an independent protocol layer, or the IoT Agent is a submodule of an NG-AP protocol layer, or the IoT Agent is a submodule of an APP protocol layer.

For example, the requirement information includes at least one of the following:
first trigger information, where the first trigger information is used to trigger the Ambient IoT service;
a service parameter corresponding to the Ambient IoT service; and
first indication information, where the first indication information is used to indicate information that needs to be reported by the first communication node.

For example, the Ambient IoT service includes inventorying a service of an Ambient IoT device within coverage of the first communication node.

For example, the service parameter includes at least one of the following:
inventory scope information, where the inventory scope information is used to indicate an Ambient IoT device that needs to be inventoried by the first communication node;
an execution period of the Ambient IoT service;
an execution time of the Ambient IoT service; and
an execution condition of the Ambient IoT service.

For example, the inventory scope information includes at least one of the following:
a device type of the Ambient IoT device that needs to be inventoried by the first communication node;
a device list of the Ambient IoT device that needs to be inventoried by the first communication node; and
a device identifier of the Ambient IoT device that needs to be inventoried by the first communication node.

For example, the related information includes at least one of the following: result information obtained by executing the Ambient IoT service by the first communication node;
location information of the first communication node;
second indication information, where the second indication information is used to indicate whether the Ambient IoT service is successfully executed;
identifier information of an Ambient IoT device that sends a feedback signal;
location information of an Ambient IoT device that sends a feedback signal;
identifier information of the first communication node;
location information of the first communication node;
timestamp information corresponding to the Ambient IoT service; and
information carried in the feedback signal.

For example, the second sending module is configured to:
send the service signal to the Ambient IoT device in a case that it is determined that a first condition is met, where
the first condition includes at least one of the following:
being within the execution period of the Ambient IoT service;
the execution time of the Ambient IoT service arrives; and
the execution condition of the Ambient IoT service is met.

For example, the first receiving module is configured to receive the feedback signal;
and the first sending module is configured to send related information to the second communication node in real time; and/or
the first sending module is configured to send one piece of related information to the second communication node after N feedback signals are received, where N is a positive integer.

For example, in a case that the first communication node is a terminal, the apparatus further includes at least one of the following:
a first state switching module, configured to enter an RRC connected state in a case that a quantity of feedback signals received by the first communication node is greater than a quantity threshold and/or a size of the related information is greater than a size threshold; and
a second state switching module, configured to maintain an RRC idle state or an RRC inactive state in a case that a quantity of feedback signals received by the first communication node is less than or equal to a quantity threshold and/or a size of the related information is less than or equal to a size threshold.

In this embodiment of this application, after receiving a feedback signal from an ambient power-enabled internet of things Ambient IoT device, a first communication node sends related information of the Ambient IoT device to a second communication node through a transmission channel of the first communication node. In this way, a bearer architecture and a transmission manner of a communication system can be greatly utilized, and a special transmission attribute configuration guarantee can be provided for the Ambient IoT device, to ensure a transmission requirement of the Ambient IoT device and avoid more complexity. This is applicable to massive Ambient IoT devices with ultra-low capabilities or ultra-low manufacturing costs, thereby improving practicability of a data transmission processing manner of the communication system for data transmission of the Ambient IoT device.

FIG. 20 is a second schematic structural diagram of a transmission apparatus according to an embodiment of this application. As shown in FIG. 20, the apparatus 2000 includes:
a third receiving module 2010, configured to receive, through a transmission channel of a second communication node, related information of an Ambient IoT device and sent by a first communication node.

In this embodiment of this application, after receiving a feedback signal from an ambient power-enabled internet of things Ambient IoT device, a first communication node sends related information of the Ambient IoT device to a second communication node through a transmission channel of the first communication node. In this way, a bearer architecture and a transmission manner of a communication system can be greatly utilized, and a special transmission attribute configuration guarantee can be provided for the Ambient IoT device, to ensure a transmission requirement of the Ambient IoT device and avoid more complexity. This is applicable to massive Ambient IoT devices with ultra-low capabilities or ultra-low manufacturing costs, thereby improving practicability of a data transmission processing manner of the communication system for data transmission of the Ambient IoT device.

For example, in a case that the first communication node includes a terminal, the related information is carried in at least one of the following:
UE NAS signaling, an SRB2, UE RRC signaling, an SRB1, a UP bearer of UE, a DRB, a data plane of UE, a bearer dedicated to Ambient IoT device data, and a first bearer, where
the first bearer is different from the SRB1, the SRB2, or the DRB.

For example, the first communication node communicates with the second communication node through an IoT Agent, where the IoT Agent is an independent protocol layer, or the IoT Agent is a submodule of a NAS protocol layer.

For example, the first communication node communicates with the second communication node through an IoT protocol layer, where the IoT protocol layer is an independent protocol layer, or the IoT protocol layer is a submodule of an RRC protocol layer, or the IoT protocol layer is a submodule of an interface protocol layer, or the IoT protocol layer is a submodule of an APP protocol layer, or the IoT protocol layer is a submodule of a first protocol layer, where the first protocol layer is different from the RRC protocol layer, the interface protocol layer, or the APP protocol layer.

For example, in a case that the first communication node includes a network node, the related information is carried in at least one of the following:
an N2/NG signaling bearer, a UP bearer of a network node, a data plane of a network node, a management plane, a PDU session, a GTP-U tunnel, and a second bearer, where
the second bearer is different from the N2/NG signaling bearer, the UP bearer of the network node, the data plane of the network node, or the management plane.

For example, the first communication node communicates with the second communication node through an IoT Agent, where the IoT Agent is an independent protocol layer, or the IoT Agent is a submodule of an NG-AP protocol layer, or the IoT Agent is a submodule of an APP protocol layer.

For example, the related information includes at least one of the following:
result information obtained by executing the Ambient IoT service by the first communication node;
location information of the first communication node;
second indication information, where the second indication information is used to indicate whether the Ambient IoT service is successfully executed;
identifier information of an Ambient IoT device that sends a feedback signal;
location information of an Ambient IoT device that sends a feedback signal;
identifier information of the first communication node;
location information of the first communication node;
timestamp information corresponding to the Ambient IoT service; and
information carried in the feedback signal.

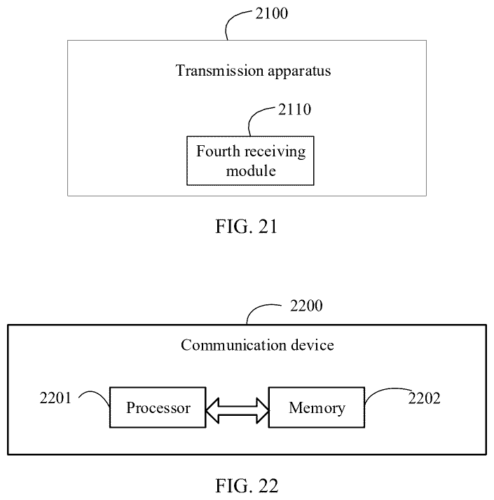

FIG. 21 is a third schematic structural diagram of a transmission apparatus according to an embodiment of this application. As shown in FIG. 21, the apparatus 2100 includes:
a fourth receiving module 2110, configured to receive, through a transmission channel of a third communication node, requirement information of an Ambient IoT service and sent by a first communication node.

In this embodiment of this application, after receiving a feedback signal from an ambient power-enabled internet of things Ambient IoT device, a first communication node sends related information of the Ambient IoT device to a second communication node through a transmission channel of the first communication node. In this way, a bearer architecture and a transmission manner of a communication system can be greatly utilized, and a special transmission attribute configuration guarantee can be provided for the Ambient IoT device, to ensure a transmission requirement of the Ambient IoT device and avoid more complexity. This is applicable to massive Ambient IoT devices with ultra-low capabilities or ultra-low manufacturing costs, thereby improving practicability of a data transmission processing manner of the communication system for data transmission of the Ambient IoT device.

For example, in a case that the first communication node includes a terminal, the requirement information is carried in at least one of the following:
UE NAS signaling, an SRB2, UE RRC signaling, an SRB1, a UP bearer of UE, a DRB, a data plane of UE, a bearer dedicated to Ambient IoT device data, and a first bearer, where
the first bearer is different from the SRB1, the SRB2, or the DRB.

For example, the first communication node communicates with the third communication node through an IoT Agent, where the IoT Agent is an independent protocol layer, or the IoT Agent is a submodule of a NAS protocol layer.

For example, the first communication node communicates with the third communication node through an IoT protocol layer, where the IoT protocol layer is an independent protocol layer, or the IoT protocol layer is a submodule of an RRC protocol layer, or the IoT protocol layer is a submodule of an interface protocol layer, or the IoT protocol layer is a submodule of an APP protocol layer, or the IoT protocol layer is a submodule of a first protocol layer, where the first protocol layer is different from the RRC protocol layer, the interface protocol layer, or the APP protocol layer.

For example, in a case that the first communication node includes a network node, the requirement information is carried in at least one of the following:
an N2/NG signaling bearer, a UP bearer of a network node, a data plane of a network node, a management plane, a PDU session, a GTP-U tunnel, and a second bearer, where
the second bearer is different from the N2/NG signaling bearer, the UP bearer of the network node, the data plane of the network node, or the management plane.

For example, the first communication node communicates with the third communication node through an IoT Agent, where the IoT Agent is an independent protocol layer, or the IoT Agent is a submodule of an NG-AP protocol layer, or the IoT Agent is a submodule of an APP protocol layer.

For example, the requirement information includes at least one of the following:
first trigger information, where the first trigger information is used to trigger the Ambient IoT service;
a service parameter corresponding to the Ambient IoT service; and
first indication information, where the first indication information is used to indicate information that needs to be reported by the first communication node.

For example, the Ambient IoT service includes inventorying a service of an Ambient IoT device within coverage of the first communication node.

For example, the service parameter includes at least one of the following:
inventory scope information, where the inventory scope information is used to indicate an Ambient IoT device that needs to be inventoried by the first communication node;
an execution period of the Ambient IT service;
an execution time of the Ambient IoT service; and
an execution condition of the Ambient IoT service.

For example, the inventory scope information includes at least one of the following:
a device type of the Ambient IoT device that needs to be inventoried by the first communication node;
a device list of the Ambient IoT device that needs to be inventoried by the first communication node; and
a device identifier of the Ambient IoT device that needs to be inventoried by the first communication node.

The transmission apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a Network Attached Storage (NAS), or the like. This is not limited in this embodiment of this application.

The transmission apparatus provided in this embodiment of this application can implement the processes implemented in the method embodiments in FIG. 2 to FIG. 18, and a same technical effect can be achieved. To avoid repetition, details are not described herein again.

For example, FIG. 22 is a schematic structural diagram of a communication device according to an embodiment of this application. As shown in FIG. 22, an embodiment of this application further provides a communication device 2200, including a processor 2201 and a memory 2202, where the memory 2202 stores a program or an instruction that can be run on the processor 2201. For example, when the communication device 2200 is a first communication node, the program or the instruction is executed by the processor 2201 to implement THE steps of the foregoing transmission method embodiment, and a same technical effect can be achieved. To avoid repetition, details are not described herein again.

An embodiment of this application further provides a first communication node, including a processor and a communication interface. The communication interface is configured to:
receive a feedback signal from an ambient power-enabled internet of things Ambient IoT device; and
send related information of the Ambient IoT device to a second communication node through a transmission channel of the first communication node.

The first communication node corresponds to the foregoing method embodiment of the first communication node. Each implementation process and implementation of the foregoing method embodiment may be applicable to the embodiment of the first communication node, and a same technical effect can be achieved.

For example, the first communication node may be a terminal.

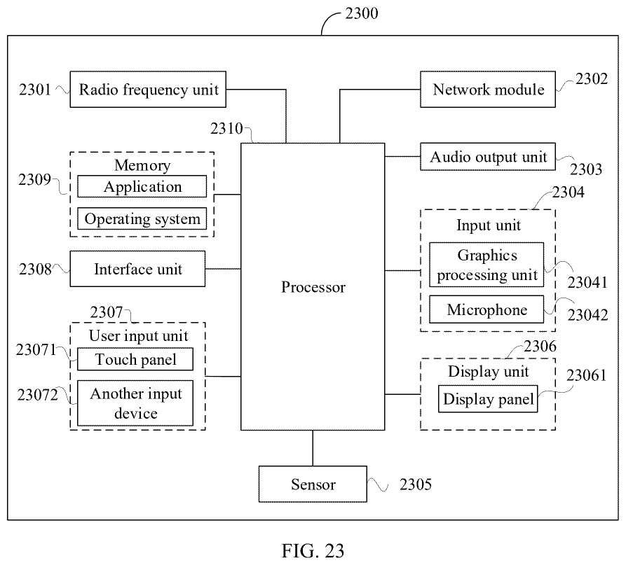

For example, FIG. 23 is a schematic structural diagram of hardware of a terminal according to an embodiment of this application.

The terminal 2300 includes but is not limited to components such as a radio frequency unit 2301, a network module 2302, an audio output unit 2303, an input unit 2304, a sensor 2305, a display unit 2306, a user input unit 2307, an interface unit 2308, a memory 2309, and a processor 2310.

It is understood that the terminal 2300 may further include the power supply (for example, a battery) that supplies power to each component. The power supply may be logically connected to the processor 2310 by using a power supply management system, so as to manage functions such as charging, discharging, and power consumption by using the power supply management system. The terminal structure shown in FIG. 23 constitutes no limitation on the terminal, and the terminal may include more or fewer components than those shown in the figure, or combine some components, or have different component arrangements. Details are not described herein.

It should be understood that, in this embodiment of this application, the input unit 2304 may include a Graphics Processing Unit (GPU) 23041 and a microphone 23042, and the graphics processing unit 23041 processes image data of a still image or a video that is obtained by an image capturing apparatus (for example, a camera) in a video capturing mode or an image capturing mode. The display unit 2306 may include a display panel 23061. The display panel 23061 may be configured in a form such as a liquid crystal display or an organic light-emitting diode. The user input unit 2307 includes at least one of a touch panel 23071 and another input device 23072. The touch panel 23071 is also referred to as a touchscreen. The touch panel 23071 may include two parts: a touch detection apparatus and a touch controller. The another input device 23072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 2301 may transmit the downlink data to the processor 2310 for processing. In addition, the radio frequency unit 2301 may send uplink data to the network side device. Usually, the radio frequency unit 2301 includes but is not limited to an antenna, an amplifier, a transceiver, a coupler, a low noise amplifier, a duplexer, and the like.

The memory 2309 may be configured to store a software program or an instruction and various data. The memory 2309 may mainly include a first storage area for storing a program or an instruction and a second storage area for storing data. The first storage area may store an operating system, and an application or an instruction required by at least one function (for example, a sound playing function or an image playing function). In addition, the memory 2309 may be a volatile memory or a non-volatile memory, or the memory 2309 may include a volatile memory and a non-volatile memory. The nonvolatile memory may be a Read-Only Memory (ROM), a programmable read-only memory (PROM), an erasable programmable read-only memory (EPROM), an electrically erasable programmable read-only memory (EEPROM), or a flash memory. The volatile memory may be a Random Access Memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchlink dynamic random access memory (SLDRAM), and a direct rambus random access memory (DRRAM). The memory 2309 in this embodiment of this application includes but is not limited to these memories and a memory of any other proper type.

The processor 2310 may include one or more processing units. For example, an application processor and a modem processor are integrated into the processor 2310. The application processor mainly processes an operating system, a user interface, an application, and the like. The modem processor mainly processes a wireless communication signal, for example, a baseband processor. It can be understood that, for example, the modem processor may not be integrated into the processor 2310.

The radio frequency unit 2301 is configured to receive a feedback signal from an ambient power-enabled internet of things Ambient IoT device; and
the radio frequency unit 2301 is configured to send related information of the Ambient IoT device to a second communication node through a transmission channel of the first communication node.

In this embodiment of this application, after receiving a feedback signal from an ambient power-enabled internet of things Ambient IoT device, a first communication node sends related information of the Ambient IoT device to a second communication node through a transmission channel of the first communication node. In this way, a bearer architecture and a transmission manner of a communication system can be greatly utilized, and a special transmission attribute configuration guarantee can be provided for the Ambient IoT device, to ensure a transmission requirement of the Ambient IoT device and avoid more complexity. This is applicable to massive Ambient IoT devices with ultra-low capabilities or ultra-low manufacturing costs, thereby improving practicability of a data transmission processing manner of the communication system for data transmission of the Ambient IoT device.

For example, the radio frequency unit 2301 is further configured to perform at least one of the following:
before the first communication node receives the feedback signal from the Ambient IoT device, receiving, through the transmission channel, requirement information of an Ambient IoT service and sent by a third communication node; and
sending a service signal to the Ambient IoT device, where the service signal is used to trigger the feedback signal.

For example, the first communication node communicates with the Ambient IoT device through an IoT layer, where the IoT layer is an independent protocol layer, or the IoT layer is a submodule of an IoT MAC layer or an IoT PHY layer.

For example, in a case that the first communication node includes a terminal, the related information is carried in at least one of the following:
UE NAS signaling, an SRB2, UE RRC signaling, an SRB1, a UP bearer of UE, a DRB, a data plane of UE, a bearer dedicated to Ambient IoT device data, and a first bearer, where
the first bearer is different from the SRB1, the SRB2, or the DRB.

For example, in a case that the first communication node includes a terminal, the requirement information is carried in at least one of the following:
UE NAS signaling, an SRB2, UE RRC signaling, an SRB1, a UP bearer of UE, a DRB, a data plane of UE, a bearer dedicated to Ambient IoT device data, and a first bearer, where
the first bearer is different from the SRB1, the SRB2, or the DRB.

For example, the first communication node communicates with the second communication node through an IoT Agent, and/or the first communication node communicates with the third communication node through an IoT Agent, where the IoT Agent is an independent protocol layer, or the IoT Agent is a submodule of a NAS protocol layer.

For example, the first communication node communicates with the second communication node through an IoT protocol layer, and/or the first communication node communicates with the third communication node through an IoT protocol layer, where the IoT protocol layer is an independent protocol layer, or the IoT protocol layer is a submodule of an RRC protocol layer, or the IoT protocol layer is a submodule of an interface protocol layer, or the IoT protocol layer is a submodule of an APP protocol layer, or the IoT protocol layer is a submodule of a first protocol layer, where the first protocol layer is different from the RRC protocol layer, the interface protocol layer, or the APP protocol layer.

For example, in a case that the first communication node includes a network node, the related information is carried in at least one of the following:
an N2/NG signaling bearer, a UP bearer of a network node, a data plane of a network node, a management plane, a PDU session, a GTP-U tunnel, and a second bearer, where
the second bearer is different from the N2/NG signaling bearer, the UP bearer of the network node, the data plane of the network node, or the management plane.

For example, in a case that the first communication node includes a network node, the requirement information is carried in at least one of the following:
an N2/NG signaling bearer, a UP bearer of a network node, a data plane of a network node, a management plane, a PDU session, a GTP-U tunnel, and a second bearer, where
the second bearer is different from the N2/NG signaling bearer, the UP bearer of the network node, the data plane of the network node, or the management plane.

For example, the first communication node communicates with the second communication node through an IoT Agent, and/or the first communication node communicates with the third communication node through an IoT Agent, where the IoT Agent is an independent protocol layer, or the IoT Agent is a submodule of an NG-AP protocol layer, or the IoT Agent is a submodule of an APP protocol layer.

For example, the requirement information includes at least one of the following:
first trigger information, where the first trigger information is used to trigger the Ambient IoT service;
a service parameter corresponding to the Ambient IoT service; and
first indication information, where the first indication information is used to indicate information that needs to be reported by the first communication node.

For example, the Ambient IoT service includes inventorying a service of an Ambient IoT device within coverage of the first communication node.

For example, the service parameter includes at least one of the following:
inventory scope information, where the inventory scope information is used to indicate an Ambient IoT device that needs to be inventoried by the first communication node;
an execution period of the Ambient IoT service;
an execution time of the Ambient IoT service; and
an execution condition of the Ambient IoT service.

For example, the inventory scope information includes at least one of the following:
a device type of the Ambient IoT device that needs to be inventoried by the first communication node;
a device list of the Ambient IoT device that needs to be inventoried by the first communication node; and
a device identifier of the Ambient IoT device that needs to be inventoried by the first communication node.

For example, the related information includes at least one of the following:
result information obtained by executing the Ambient IoT service by the first communication node;
location information of the first communication node;
second indication information, where the second indication information is used to indicate whether the Ambient IoT service is successfully executed;
identifier information of an Ambient IoT device that sends a feedback signal;
location information of an Ambient IoT device that sends a feedback signal;
identifier information of the first communication node;
location information of the first communication node;
timestamp information corresponding to the Ambient IoT service; and
information carried in the feedback signal.

For example, the radio frequency unit 2301 is configured to:
send the service signal to the Ambient IoT device in a case that it is determined that a first condition is met, where
the first condition includes at least one of the following:
being within the execution period of the Ambient IoT service;
the execution time of the Ambient IoT service arrives; and
the execution condition of the Ambient IoT service is met.

For example, the radio frequency unit 2301 is configured to receive the feedback signal and send related information to the second communication node in real time; and/or
the radio frequency unit 2301 is configured to send one piece of related information to the second communication node after receiving N feedback signals, where N is a positive integer.

For example, in a case that the first communication node is a terminal, the processor 2310 is configured to perform at least one of the following:
entering an RRC connected state in a case that a quantity of feedback signals received by the first communication node is greater than a quantity threshold and/or a size of the related information is greater than a size threshold; and
maintaining an RRC idle state or an RRC inactive state in a case that a quantity of feedback signals received by the first communication node is less than or equal to a quantity threshold and/or a size of the related information is less than or equal to a size threshold.

In this embodiment of this application, after receiving a feedback signal from an ambient power-enabled internet of things Ambient IoT device, a first communication node sends related information of the Ambient IoT device to a second communication node through a transmission channel of the first communication node. In this way, a bearer architecture and a transmission manner of a communication system can be greatly utilized, and a special transmission attribute configuration guarantee can be provided for the Ambient IoT device, to ensure a transmission requirement of the Ambient IoT device and avoid more complexity. This is applicable to massive Ambient IoT devices with ultra-low capabilities or ultra-low manufacturing costs, thereby improving practicability of a data transmission processing manner of the communication system for data transmission of the Ambient IoT device.

For example, the first communication node may be a network node.

An embodiment of this application further provides a network node, including a processor and a communication interface. The communication interface is configured to:
receive a feedback signal from an ambient power-enabled internet of things Ambient IoT device; and
send related information of the Ambient IoT device to a second communication node through a transmission channel of the first communication node.

This network node embodiment corresponds to the foregoing method embodiment of the first communication node. Each implementation process and implementation of the foregoing method embodiment may be applicable to this network node embodiment, and a same technical effect can be achieved.

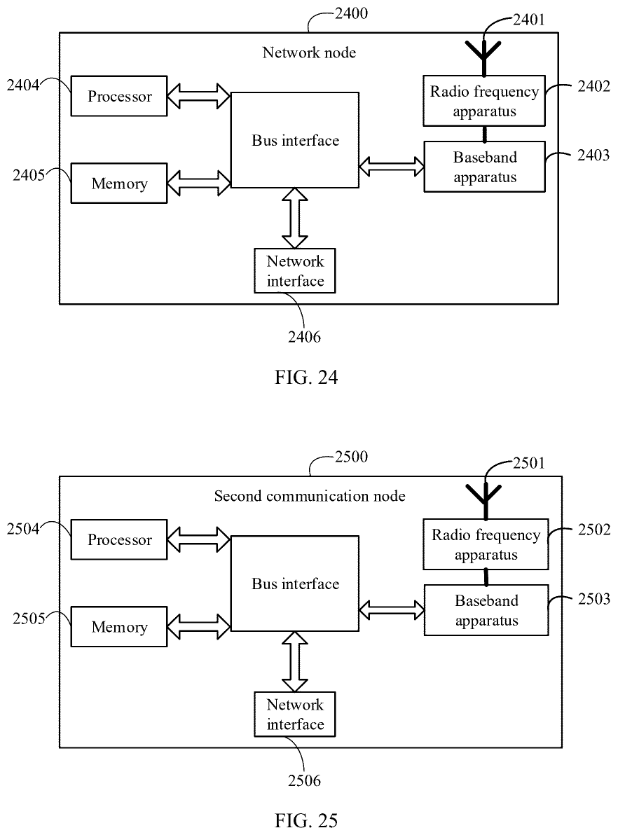

For example, an embodiment of this application further provides a network node. FIG. 24 is a schematic structural diagram of hardware of a network node according to an embodiment of this application. As shown in FIG. 24, the network node 2400 includes an antenna 2401, a radio frequency apparatus 2402, a baseband apparatus 2403, a processor 2404, and a memory 2405. The antenna 2401 is connected to the radio frequency apparatus 2402. In an uplink direction, the radio frequency apparatus 2402 receives information by using the antenna 2401, and sends the received information to the baseband apparatus 2403 for processing. In a downlink direction, the baseband apparatus 2403 processes information that needs to be sent, and sends processed information to the radio frequency apparatus 2402. The radio frequency apparatus 2402 processes the received information, and sends processed information by using the antenna 2401.

In the foregoing embodiment, the method executed by the network node may be implemented in the baseband apparatus 2403. The baseband apparatus 2403 includes a baseband processor.

The baseband apparatus 2403 may include, for example, at least one baseband board, where a plurality of chips are disposed on the baseband board. As shown in FIG. 24, one chip is, for example, the baseband processor, is connected to the memory 2405 through a bus interface, to invoke a program in the memory 2405 to perform the operations of the first communication node shown in the foregoing method embodiment.

The network node may further include a network interface 2406, and the interface is, for example, a common public radio interface (CPRI).

For example, the network node 2400 in this embodiment of the present disclosure further includes an instruction or a program that is stored in the memory 2405 and that can be run on the processor 2404. The processor 2404 invokes the instruction or the program in the memory 2405 to execute the method executed by the modules shown in FIG. 19, and a same technical effect is achieved. To avoid repetition, details are not described herein again.

The radio frequency apparatus 2402 is configured to receive a feedback signal from an ambient power-enabled internet of things Ambient IoT device.

The radio frequency apparatus 2402 is configured to send related information of the Ambient IoT device to a second communication node through a transmission channel of a first communication node.

In this embodiment of this application, after receiving a feedback signal from an ambient power-enabled internet of things Ambient IoT device, a first communication node sends related information of the Ambient IoT device to a second communication node through a transmission channel of the first communication node. In this way, a bearer architecture and a transmission manner of a communication system can be greatly utilized, and a special transmission attribute configuration guarantee can be provided for the Ambient IoT device, to ensure a transmission requirement of the Ambient IoT device and avoid more complexity. This is applicable to massive Ambient IoT devices with ultra-low capabilities or ultra-low manufacturing costs, thereby improving practicability of a data transmission processing manner of the communication system for data transmission of the Ambient IoT device.

For example, the radio frequency apparatus 2402 is further configured to perform at least one of the following:
before the first communication node receives the feedback signal from the Ambient IoT device, receiving, through the transmission channel, requirement information of an Ambient IoT service and sent by a third communication node; and
sending a service signal to the Ambient IoT device, where the service signal is used to trigger the feedback signal.

For example, the first communication node communicates with the Ambient IoT device through an IoT layer, where the IoT layer is an independent protocol layer, or the IoT layer is a submodule of an IoT MAC layer or an IoT PHY layer.

For example, in a case that the first communication node includes a terminal, the related information is carried in at least one of the following:
UE NAS signaling, an SRB2, UE RRC signaling, an SRB1, a UP bearer of UE, a DRB, a data plane of UE, a bearer dedicated to Ambient IoT device data, and a first bearer, where
the first bearer is different from the SRB1, the SRB2, or the DRB.

For example, in a case that the first communication node includes a terminal, the requirement information is carried in at least one of the following:
UE NAS signaling, an SRB2, UE RRC signaling, an SRB1, a UP bearer of UE, a DRB, a data plane of UE, a bearer dedicated to Ambient IoT device data, and a first bearer, where
the first bearer is different from the SRB1, the SRB2, or the DRB.

For example, the first communication node communicates with the second communication node through an IoT Agent, and/or the first communication node communicates with the third communication node through an IoT Agent, where the IoT Agent is an independent protocol layer, or the IoT Agent is a submodule of a NAS protocol layer.

For example, the first communication node communicates with the second communication node through an IoT protocol layer, and/or the first communication node communicates with the third communication node through an IoT protocol layer, where the IoT protocol layer is an independent protocol layer, or the IoT protocol layer is a submodule of an RRC protocol layer, or the IoT protocol layer is a submodule of an interface protocol layer, or the IoT protocol layer is a submodule of an APP protocol layer, or the IoT protocol layer is a submodule of a first protocol layer, where the first protocol layer is different from the RRC protocol layer, the interface protocol layer, or the APP protocol layer.

For example, in a case that the first communication node includes a network node, the related information is carried in at least one of the following:
an N2/NG signaling bearer, a UP bearer of a network node, a data plane of a network node, a management plane, a PDU session, a GTP-U tunnel, and a second bearer, where
the second bearer is different from the N2/NG signaling bearer, the UP bearer of the network node, the data plane of the network node, or the management plane.

For example, in a case that the first communication node includes a network node, the requirement information is carried in at least one of the following:
an N2/NG signaling bearer, a UP bearer of a network node, a data plane of a network node, a management plane, a PDU session, a GTP-U tunnel, and a second bearer, where
the second bearer is different from the N2/NG signaling bearer, the UP bearer of the network node, the data plane of the network node, or the management plane.

For example, the first communication node communicates with the second communication node through an IoT Agent, and/or the first communication node communicates with the third communication node through an IoT Agent, where the IoT Agent is an independent protocol layer, or the IoT Agent is a submodule of an NG-AP protocol layer, or the IoT Agent is a submodule of an APP protocol layer.

For example, the requirement information includes at least one of the following:
first trigger information, where the first trigger information is used to trigger the Ambient IoT service;
a service parameter corresponding to the Ambient IoT service; and
first indication information, where the first indication information is used to indicate information that needs to be reported by the first communication node.

For example, the Ambient IoT service includes inventorying a service of an Ambient IoT device within coverage of the first communication node.

For example, the service parameter includes at least one of the following:
inventory scope information, where the inventory scope information is used to indicate an Ambient IoT device that needs to be inventoried by the first communication node;
an execution period of the Ambient IoT service;
an execution time of the Ambient IoT service; and
an execution condition of the Ambient IoT service.

For example, the inventory scope information includes at least one of the following:
a device type of the Ambient IoT device that needs to be inventoried by the first communication node;
a device list of the Ambient IoT device that needs to be inventoried by the first communication node; and
a device identifier of the Ambient IoT device that needs to be inventoried by the first communication node.

For example, the related information includes at least one of the following:
result information obtained by executing the Ambient IT service by the first communication node;
location information of the first communication node;
second indication information, where the second indication information is used to indicate whether the Ambient IoT service is successfully executed;
identifier information of an Ambient IoT device that sends a feedback signal;
location information of an Ambient IoT device that sends a feedback signal;
identifier information of the first communication node;
location information of the first communication node;
timestamp information corresponding to the Ambient IoT service; and
information carried in the feedback signal.

For example, the radio frequency apparatus 2402 is configured to:
send the service signal to the Ambient IoT device in a case that it is determined that a first condition is met, where
the first condition includes at least one of the following:
being within the execution period of the Ambient IoT service;
the execution time of the Ambient IoT service arrives; and
the execution condition of the Ambient IoT service is met.

For example, the radio frequency apparatus 2402 is configured to receive the feedback signal and send related information to the second communication node in real time; and/or
the radio frequency apparatus 2402 is configured to send one piece of related information to the second communication node after receiving N feedback signals, where N is a positive integer.

For example, in a case that the first communication node is a terminal, the processor 2004 is configured to perform at least one of the following:
entering an RRC connected state in a case that a quantity of feedback signals received by the first communication node is greater than a quantity threshold and/or a size of the related information is greater than a size threshold; and
maintaining an RRC idle state or an RRC inactive state in a case that a quantity of feedback signals received by the first communication node is less than or equal to a quantity threshold and/or a size of the related information is less than or equal to a size threshold.

In this embodiment of this application, after receiving a feedback signal from an ambient power-enabled internet of things Ambient IoT device, a first communication node sends related information of the Ambient IoT device to a second communication node through a transmission channel of the first communication node. In this way, a bearer architecture and a transmission manner of a communication system can be greatly utilized, and a special transmission attribute configuration guarantee can be provided for the Ambient IoT device, to ensure a transmission requirement of the Ambient IoT device and avoid more complexity. This is applicable to massive Ambient IoT devices with ultra-low capabilities or ultra-low manufacturing costs, thereby improving practicability of a data transmission processing manner of the communication system for data transmission of the Ambient IoT device.

An embodiment of this application further provides a second communication node, including a processor and a communication interface. The communication interface is configured to receive, through a transmission channel of the second communication node, related information of an Ambient IoT device and sent by a first communication node.

This second communication node embodiment corresponds to the foregoing method embodiment of the second communication node. Each implementation process and implementation of the foregoing method embodiment may be applicable to this second communication node embodiment, and a same technical effect can be achieved.

For example, an embodiment of this application further provides a second communication node. FIG. 25 is a schematic structural diagram of hardware of a second communication node according to an embodiment of this application. As shown in FIG. 25, the second communication node 2500 includes an antenna 2501, a radio frequency apparatus 2502, a baseband apparatus 2503, a processor 2504, and a memory 2505. The antenna 2501 is connected to the radio frequency apparatus 2502. In an uplink direction, the radio frequency apparatus 2502 receives information by using the antenna 2501, and sends the received information to the baseband apparatus 2503 for processing. In a downlink direction, the baseband apparatus 2503 processes information that needs to be sent, and sends processed information to the radio frequency apparatus 2502. The radio frequency apparatus 2502 processes the received information, and sends processed information by using the antenna 2501.

In the foregoing embodiment, the method executed by the second communication node may be implemented in the baseband apparatus 2503. The baseband apparatus 2503 includes a baseband processor.

The baseband apparatus 2503 may include, for example, at least one baseband board, where a plurality of chips are disposed on the baseband board. As shown in FIG. 25, one chip is, for example, the baseband processor, is connected to the memory 2505 through a bus interface, to invoke a program in the memory 2505 to perform the operations of the second communication node shown in the foregoing method embodiment.

The second communication node may further include a network interface 2506, and the interface is, for example, a common public radio interface (CPRI).

For example, the second communication node 2500 in this embodiment of the present disclosure further includes an instruction or a program that is stored in the memory 2505 and that can be run on the processor 2504. The processor 2504 invokes the instruction or the program in the memory 2505 to execute the method executed by the modules shown in FIG. 20, and a same technical effect is achieved. To avoid repetition, details are not described herein again.

An embodiment of this application further provides a third communication node, including a processor and a communication interface. The communication interface is configured to receive, through a transmission channel of the third communication node, requirement information of an Ambient IoT service and sent by a first communication node.

This third communication node embodiment corresponds to the foregoing method embodiment of the third communication node. Each implementation process and implementation of the foregoing method embodiment may be applicable to this third communication node embodiment, and a same technical effect can be achieved.

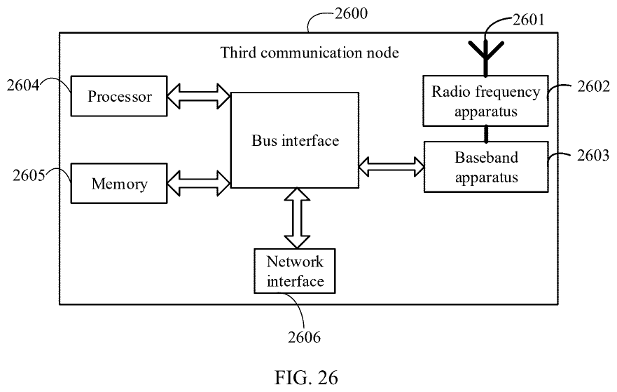

For example, an embodiment of this application further provides a third communication node. FIG. 26 is a schematic structural diagram of hardware of a third communication node according to an embodiment of this application. As shown in FIG. 26, the third communication node 2600 includes an antenna 2601, a radio frequency apparatus 2602, a baseband apparatus 2603, a processor 2604, and a memory 2605. The antenna 2601 is connected to the radio frequency apparatus 2602. In an uplink direction, the radio frequency apparatus 2602 receives information by using the antenna 2601, and sends the received information to the baseband apparatus 2603 for processing. In a downlink direction, the baseband apparatus 2603 processes information that needs to be sent, and sends processed information to the radio frequency apparatus 2602. The radio frequency apparatus 2602 processes the received information, and sends processed information by using the antenna 2601.

In the foregoing embodiment, the method executed by the third communication node may be implemented in the baseband apparatus 2603. The baseband apparatus 2603 includes a baseband processor.

The baseband apparatus 2603 may include, for example, at least one baseband board, where a plurality of chips are disposed on the baseband board. As shown in FIG. 26, one chip is, for example, the baseband processor, is connected to the memory 2605 through a bus interface, to invoke a program in the memory 2605 to perform the operations of the third communication node shown in the foregoing method embodiment.

The third communication node may further include a network interface 2606, and the interface is, for example, a common public radio interface (CPRI).

For example, the third communication node 2600 in this embodiment of the present disclosure further includes an instruction or a program that is stored in the memory 2605 and that can be run on the processor 2604. The processor 2604 invokes the instruction or the program in the memory 2605 to execute the method executed by the modules shown in FIG. 21, and a same technical effect is achieved. To avoid repetition, details are not described herein again.

An embodiment of this application further provides a readable storage medium. The readable storage medium stores a program or an instruction, and the program or the instruction is executed by a processor to implement the processes of the foregoing transmission method embodiment, and a same technical effect can be achieved. To avoid repetition, details are not described herein again.

The processor is a processor in the terminal in the foregoing embodiment. The readable storage medium includes a computer readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing transmission method embodiment, and a same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of this application further provides a computer program/program product. The computer program/program product is stored in a storage medium, and the program/program product is executed by at least one processor to implement the processes of the foregoing transmission method embodiment, and a same technical effect can be achieved. To avoid repetition, details are not described herein again.

An embodiment of this application further provides a transmission system, including a first communication node, a second communication node, and a third communication node. The first communication node may be configured to execute the steps of the transmission method, the second communication node may be configured to execute the steps of the transmission method, and the third communication node may be configured to execute the steps of the transmission method.

It should be noted that, in this specification, the terms “include”, “comprise”, or their any other variant are intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element preceded by “includes a . . . ” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the foregoing descriptions of the embodiments, it is understood that the method in the foregoing embodiment may be implemented by software in addition to a necessary universal hardware platform or by hardware only. In most circumstances, the former is an example implementation. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the above specific implementations, and the above specific implementations are merely illustrative but not restrictive. Under the enlightenment of this application, a person of ordinary skill in the art can make many forms without departing from the purpose of this application and the protection scope of the claims, all of which fall within the protection of this application.

1. A transmission method, comprising:
receiving, by a first communication node, a feedback signal from an ambient power-enabled internet of things (Ambient IoT) device; and
sending, by the first communication node, related information of the Ambient IoT device to a second communication node through a transmission channel of the first communication node.

2. The transmission method according to claim 1, wherein before the receiving, by a first communication node, a feedback signal from an Ambient IoT device, the method further comprises at least one of the following:
receiving, by the first communication node through the transmission channel, requirement information of an Ambient IoT service and sent by a third communication node; or
sending, by the first communication node, a service signal to the Ambient IoT device, wherein the service signal is used to trigger the feedback signal.

3. The transmission method according to claim 2, wherein the first communication node comprises a terminal or a network node; the second communication node comprises at least one of the following: a base station, a core network node, an IoT server, an external node, or an IoT control node; and the third communication node comprises at least one of the following: a base station, a core network node, an IoT server, an external node, or an IoT control node.

4. The transmission method according to claim 1, wherein the first communication node communicates with the Ambient IoT device through an internet of things (IoT) layer, wherein the IoT layer is an independent protocol layer, or the IoT layer is a submodule of an internet of things medium access control (IoT MAC) layer or an internet of things physical (IoT PHY) layer.

5. The transmission method according to claim 1, wherein when the first communication node comprises a terminal, the related information is carried in at least one of the following:
User Equipment non-access stratum (UE NAS) signaling, a signaling radio bearer 2 (SRB2), UE radio resource control (UE RRC) signaling, a signaling radio bearer 1 (SRB1), a user plane (UP) bearer of the terminal, a data radio bearer (DRB), a data plane of the terminal, a bearer dedicated to Ambient IoT device data, or a first bearer, wherein
the first bearer is different from the SRB1, the SRB2, or the DRB.

6. The transmission method according to claim 2, wherein when the first communication node comprises a terminal, the requirement information is carried in at least one of the following:
User Equipment non-access stratum (UE NAS) signaling, a signaling radio bearer 2 (SRB2), UE radio resource control (UE RRC) signaling, a signaling radio bearer 1 (SRB1), a user plane (UP) bearer of the terminal, a data radio bearer (DRB), a data plane of the terminal, a bearer dedicated to Ambient IoT device data, and a first bearer, wherein
the first bearer is different from the SRB1, the SRB2, or the DRB.

7. The transmission method according to claim 5, wherein the first communication node communicates with the second communication node through an IoT agent, or the first communication node communicates with the third communication node through an IoT Agent, wherein the IoT Agent is an independent protocol layer, or the IoT Agent is a submodule of a NAS protocol layer.

8. The transmission method according to claim 5, wherein the first communication node communicates with the second communication node through an IoT protocol layer, or the first communication node communicates with the third communication node through an IoT protocol layer, wherein the IoT protocol layer is an independent protocol layer, or the IoT protocol layer is a submodule of a radio resource control (RRC) protocol layer, or the IoT protocol layer is a submodule of an interface protocol layer, or the IoT protocol layer is a submodule of an application (APP) protocol layer, or the IoT protocol layer is a submodule of a first protocol layer, wherein the first protocol layer is different from the RRC protocol layer, the interface protocol layer, or the APP protocol layer.

9. The transmission method according to claim 1, wherein when the first communication node comprises a network node, the related information is carried in at least one of the following:
an N2/NG signaling bearer, a user plane (UP) bearer of the network node, a data plane of the network node, a management plane, a protocol data unit (PDU) session, a General Packet Radio Service (GPRS) tunneling protocol-user plane (GTP-U) tunnel, and a second bearer, wherein
the second bearer is different from the N2/NG signaling bearer, the UP bearer of the network node, the data plane of the network node, or the management plane.

10. The transmission method according to according to claim 2, wherein when the first communication node comprises a network node, the requirement information is carried in at least one of the following:
an N2/NG signaling bearer, a user plane (UP) bearer of the network node, a data plane of the network node, a management plane, a protocol data unit (PDU) session, a General Packet Radio Service (GPRS) tunneling protocol-user plane (GTP-U) tunnel, and a second bearer, wherein
the second bearer is different from the N2/NG signaling bearer, the UP bearer of the network node, the data plane of the network node, or the management plane.

11. The transmission method according to claim 9, wherein the first communication node communicates with the second communication node through an IoT Agent, or the first communication node communicates with the third communication node through an IoT Agent, wherein the IoT Agent is an independent protocol layer, or the IoT Agent is a submodule of an Next Generation-Application Protocol (NG-AP) protocol layer, or the IoT Agent is a submodule of an application (APP) protocol layer.

12. The transmission method according to claim 2, wherein the requirement information comprises at least one of the following:
first trigger information, wherein the first trigger information is used to trigger the Ambient IoT service;
a service parameter corresponding to the Ambient IoT service; or
first indication information, wherein the first indication information is used to indicate information that needs to be reported by the first communication node.

13. The transmission method according to claim 12, wherein the Ambient IoT service comprises inventorying a service of an Ambient IoT device within coverage of the first communication node.

14. The transmission method according to claim 12, wherein the service parameter comprises at least one of the following:
inventory scope information, wherein the inventory scope information is used to indicate an Ambient IoT device that needs to be inventoried by the first communication node;
an execution period of the Ambient IoT service;
an execution time of the Ambient IoT service; or
an execution condition of the Ambient IoT service.

15. The transmission method according to claim 14, wherein the inventory scope information comprises at least one of the following:
a device type of the Ambient IoT device that needs to be inventoried by the first communication node;
a device list of the Ambient IoT device that needs to be inventoried by the first communication node; or
a device identifier of the Ambient IoT device that needs to be inventoried by the first communication node.

16. The transmission method according to claim 1, wherein the related information comprises at least one of the following:
result information obtained by executing the Ambient IoT service by the first communication node;
location information of the first communication node;
second indication information, wherein the second indication information is used to indicate whether the Ambient IoT service is successfully executed;
identifier information of an Ambient IoT device that sends a feedback signal;
location information of an Ambient IoT device that sends a feedback signal;
identifier information of the first communication node;
location information of the first communication node;
timestamp information corresponding to the Ambient IoT service; or
information carried in the feedback signal.

17. The transmission method according to claim 1, wherein the receiving, by a first communication node, a feedback signal from an ambient power-enabled internet of things Ambient IoT device, and sending, by the first communication node, related information of the Ambient IoT device to a second communication node through a transmission channel of the first communication node comprises at least one of the following:
receiving, by the first communication node, the feedback signal, and sending related information to the second communication node in real time; or
sending, by the first communication node, one piece of related information to the second communication node after receiving N feedback signals, wherein N is a positive integer.

18. The transmission method according to claim 1, wherein when the first communication node is a terminal, the method further comprises at least one of the following:
entering, by the first communication node, a radio resource control (RRC) connected state when a quantity of feedback signals received by the first communication node is greater than a quantity threshold or a size of the related information is greater than a size threshold; or
maintaining, by the first communication node, an RRC idle state or an RRC inactive state when a quantity of feedback signals received by the first communication node is less than or equal to a quantity threshold or a size of the related information is less than or equal to a size threshold.

19. A communication node, comprising a processor and a memory, wherein the memory storing a program or an instruction that, when executed by the processor, causes the communication node to perform operations comprising:
receiving a feedback signal from an ambient power-enabled internet of things (Ambient IoT) device; and
sending related information of the Ambient IoT device to a second communication node through a transmission channel of the first communication node.

20. A non-transitory readable storage medium, storing a program or an instruction that, when executed by a processor, causes the processor to perform operations comprising:
receiving a feedback signal from an ambient power-enabled internet of things (Ambient IoT) device; and
sending related information of the Ambient IoT device to a second communication node through a transmission channel of the first communication node.
